(19) United States
(12) Patent Application Publication
(10) Pub. No.: US 2025/0298363 A1
(43) Pub. Date: Sep. 25, 2025

(54) IMAGE FORMING APPARATUS AND METHOD FOR COLLECTING TRANSFER RESIDUAL TONER

(71) Applicants: Akihiro KAWASAKI, Kanagawa (JP); Yasuhide MATSUNO, Kanagawa (JP); Yutaro KAKU, Kanagawa (JP); Shuichi NAKAGAWA, Kanagawa (JP); Hiroaki KATO, Kanagawa (JP); Shintaro YAMADA, Osaka (JP); Taira OTSUKA, Kanagawa (JP)

(72) Inventors: Akihiro KAWASAKI, Kanagawa (JP); Yasuhide MATSUNO, Kanagawa (JP); Yutaro KAKU, Kanagawa (JP); Shuichi NAKAGAWA, Kanagawa (JP); Hiroaki KATO, Kanagawa (JP); Shintaro YAMADA, Osaka (JP); Taira OTSUKA, Kanagawa (JP)

(73) Assignee: Ricoh Company, Ltd., Tokyo (JP)

(21) Appl. No.: 19/074,613

(22) Filed: Mar. 10, 2025

(30) Foreign Application Priority Data
Mar. 19, 2024 (JP) 2024-043758

(51) Int. Cl. G03G 21/00; G03G 15/02; G03G 15/16

(52) U.S. Cl. CPC G03G 21/0064; G03G 15/0266; G03G 15/1675

(57) ABSTRACT

An image forming apparatus includes an image bearer, a charger, a charging power source, a developing device, a transferor, a transfer power source, and circuitry. During an image printing period, the circuitry performs a first collection operation to move reversely charged toner from the image bearer to the charger. During a non-image printing period, the circuitry performs a second collection operation including processes (a) to (c). In the process (a), the circuitry controls the charging power source and the transfer power source to change voltages applied to the charger and the transferor to move the reversely charged toner from the charger to the image bearer. In the process (b), the circuitry controls the transfer power source to reduce the potential of the image bearer. In the process (c), the circuitry controls the developing device to move toner from the image bearer to the developing device.

### CROSS-REFERENCE TO RELATED APPLICATIONS

This patent application is based on and claims priority pursuant to 35 U.S.C. § 119 (a) to Japanese Patent Application No. 2024-043758, filed on Mar. 19, 2024, in the Japan Patent Office, the entire disclosure of which is hereby incorporated by reference herein.

### BACKGROUND

### Technical Field

The present disclosure relates to an image forming apparatus and a method for collecting transfer residual toner.

### Related Art

An electrophotographic image forming apparatus includes a charger such as a charging roller to charge an image bearer such as a photoconductor, a developing device to supply toner to the photoconductor, and a transfer device to transfer the toner on the photoconductor to a recording medium or an intermediate transferor.

In addition, the electrographic image forming apparatus includes a cleaner such as a cleaning blade to clean the toner adhered to the photoconductor. In recent years, a so-called cleanerless system has been proposed to downsize the image forming apparatus. The image forming apparatus employing the cleanerless system, which is referred to as a cleanerless image forming apparatus, does not include the cleaner dedicated to cleaning the photoconductor.

In the cleanerless image forming apparatus, the developing device collects transfer residual toner remaining on the photoconductor after the toner is transferred. Since the developing device collects and reuses the transfer residual toner, the cleanerless image forming apparatus can reduce waste toner. As a result, the cleanerless system can simplify user maintenance and does not require a waste toner container, which reduces waste.

### SUMMARY

The present disclosure described herein provides an image forming apparatus including an image bearer, a charger, a charging power source, a developing device, a transferor, a transfer power source, and circuitry. The image bearer is rotatable in a rotation direction. The charger is in contact with the image bearer to charge the image bearer. The charging power source applies voltage to the charger. The developing device charges toner to a first polarity, supplies toner to the image bearer, and forms a toner image on the image bearer. The transferor faces the image bearer to transfer the toner image onto a transfer medium at a transfer position. The transfer power source applies voltage to the transferor. During an image printing period, the circuitry is configured to perform a first collection operation to collect, to the charger, a part of transfer residual toner remaining on the image bearer after the transferor transfers the toner image to the transfer medium. During a non-image printing period, the circuitry is configured to perform a second collection operation to move the transfer residual toner collected to the charger from the charger to the developing device via the image bearer. The circuitry is further configured to perform the first collection operation to move reversely charged toner that is charged to a second polarity opposite the first polarity from the image bearer to the charger applied with a direct current bias with a first voltage having a first absolute value. The circuitry is further configured to perform the second collection operation to perform a first process (a), a second process (b), and a third process (c). In the first process (a), the circuitry is configured to control the transfer power source to stop applying the voltage to the transferor or to apply the transferor a second voltage having the first polarity opposite the second polarity of a third voltage applied to the transferor during the image printing period and control the charging power source to apply the charger a fourth voltage having a second absolute value smaller than the first absolute value of the first voltage to move the reversely charged toner from the charger to the image bearer. In the second process (b), the circuitry is configured to control the transfer power source to apply the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. In the second process (b), the circuitry is configured to control the charging power source to apply the charger a sixth voltage having an absolute value larger than the second absolute value of the fourth voltage. In the third process (c), the circuitry is configured to control the developing device to move toner having the first polarity from the image bearer to the developing device.

The present disclosure described herein also provides a method performed by an image forming apparatus. The image forming apparatus includes an image bearer rotatable in a rotation direction, a charger in contact with the image bearer to charge the image bearer, a developing device to charge toner to a first polarity, supply toner to the image bearer, and form a toner image on the image bearer, and a transferor facing the image bearer to transfer the toner image to a transfer medium at a transfer position. The method is performed to collect transfer residual toner remaining on the image bearer after the transferor transfers the toner image. The method includes performing a first collection operation during an image printing period to collect a part of the transfer residual toner to the charger and performing a second collection operation during a non-image printing period to move the transfer residual toner collected to the charger from the charger to the developing device via the image bearer. The first collection operation includes moving reversely charged toner that is charged to a second polarity opposite the first polarity from the image bearer to the charger applied with a direct current bias with a first voltage having a first absolute value. The second collection operation includes performing a first process (a), a second process (b), and a third process (c). The first process (a) includes either stopping applying a voltage to the transferor or applying the transferor a second voltage having the first polarity opposite the second polarity of a third voltage applied to the transferor during the image printing period. The first process (a) includes applying the charger a fourth voltage having a second absolute value smaller than the first absolute value of the first voltage to move the reversely charged toner from the charger to the image bearer. The second process (b) includes applying the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. The second process (b) includes applying the charger a sixth voltage having an absolute value larger than the second absolute value of the fourth voltage. The third process (c) includes moving toner having the first polarity from the image bearer to the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an image forming apparatus;

FIG. 2A is a block diagram of a hardware configuration of a controller and power sources;

FIG. 2B is a block diagram of a hardware configuration regarding the controller of FIG. 2A;

FIG. 3 is a schematic diagram illustrating a basic configuration of a cleanerless image forming apparatus;

FIG. 4 is a schematic diagram illustrating processes during printing in the cleanerless image forming apparatus of FIG. 3;

FIG. 5A is a schematic diagram illustrating shutdown processes in the cleanerless image forming apparatus of FIG. 3;

FIG. 5B is a schematic diagram illustrating shutdown processes subsequent to the processes of FIG. 5A;

FIG. 6 is a schematic diagram illustrating processes during printing in the cleanerless image forming apparatus including a charging brush roller instead of a charging roller in the cleanerless image forming apparatus of FIG. 3;

FIG. 7A is a schematic diagram illustrating shutdown processes in the cleanerless image forming apparatus of FIG. 6;

FIG. 7B is a schematic diagram illustrating shutdown processes subsequent to the processes of FIG. 7A;

FIG. 8 is a timing chart illustrating control processes applicable to the above cleanerless image forming apparatuses;

FIG. 9 is a timing chart illustrating a transfer cleaning operation in addition to the control processes of FIG. 8;

FIG. 10 is a timing chart illustrating a charger cleaning operation in addition to the control processes of FIG. 8;

FIG. 11 is a timing chart illustrating a transfer cleaning operation in addition to the control processes of FIG. 10; and

FIG. 12 is a schematic diagram illustrating a basic configuration of a cleanerless image forming apparatus including a transfer contact-separation mechanism in addition to the basic configuration of the cleanerless image forming apparatus of FIG. 3.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is provided of an image forming apparatus and a method to collect transfer residual toner with reference to the drawings. It is to be noted that the present disclosure is not to be considered limited to the following embodiments but can be changed within the range that can be conceived of by those skilled in the art, such as other embodiments, additions, modifications, deletions, and the scope of the present disclosure encompasses any aspect, as long as the aspect achieves the operation and advantageous effect of the present disclosure.

The image forming apparatus according to the present disclosure includes an image bearer, a charger, a charging power source, a developing device, a transferor, a transfer power source, and a controller that is circuitry. The image bearer is rotatable in a rotation direction. The charger is in contact with the image bearer to charge the image bearer. The charging power source applies a voltage to the charger. The developing device charges toner to a first polarity, supplies toner to the image bearer, and forms a toner image on the image bearer. The transferor faces the image bearer to transfer the toner image onto a transfer medium at a transfer position. The transfer power source applies a voltage to the transferor. During an image printing period, the controller is configured to perform a first collection operation to collect, to the charger, a part of transfer residual toner remaining on the image bearer after the transferor transfers the toner image to the transfer medium. During a non-image printing period, the controller is configured to perform a second collection operation to move the transfer residual toner collected to the charger from the charger to the developing device via the image bearer. The controller is further configured to perform the first collection operation to move reversely charged toner that is charged to a second polarity opposite the first polarity from the image bearer to the charger applied with a direct current bias with a first voltage having a first absolute value. The controller is further configured to perform the second collection operation to perform a first process (a), a second process (b), and a third process (c). In the first process (a), the controller is configured to control the transfer power source to stop applying the voltage to the transferor or to apply the transferor a second voltage having the first polarity opposite the second polarity of a third voltage applied to the transferor during the image printing period and control the charging power source to apply the charger a fourth voltage having a second absolute value smaller than the first absolute value of the first voltage to move the reversely charged toner from the charger to the image bearer. In the second process (b), the controller is configured to control the transfer power source to apply the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. In the second process (b), the controller is configured to control the charging power source to apply the charger a sixth voltage having an absolute value larger than the second absolute value of the fourth voltage. In the third process (c), the controller is configured to control the developing device to move toner having the first polarity from the image bearer to the developing device.

The image forming apparatus may be referred to as an electrophotographic apparatus or a printer. The image forming apparatus of the present disclosure may be a cleanerless image forming apparatus. The cleanerless system may be referred to as a cleanerless image forming system.

The method to collect the transfer residual toner according to the present disclosure is performed by an image forming apparatus including an image bearer rotatable in a rotation direction, a charger in contact with the image bearer to charge the image bearer, a developing device to charge toner to a first polarity, supply toner to the image bearer, and form a toner image on the image bearer, and a transferor facing the image bearer to transfer the toner image to a transfer medium at a transfer position. The method is performed to collect transfer residual toner remaining on the image bearer after the transferor transfers the toner image. The method includes performing a first collection operation during an image printing period to collect a part of the transfer residual toner to the charger and performing a second collection operation during a non-image printing period to move the transfer residual toner collected to the charger from the charger to the developing device via the image bearer. The first collection operation includes moving reversely charged toner that is charged to a second polarity opposite the first polarity from the image bearer to the charger applied with a direct current bias with a first voltage having a first absolute value. The second collection operation includes performing a first process (a), a second process (b), and a third process (c). The first process (a) includes either stopping applying a voltage to the transferor or applying the transferor a second voltage having the first polarity opposite the second polarity of a third voltage applied to the transferor during the image printing period. The first process (a) includes applying the charger a fourth voltage having a second absolute value smaller than the first absolute value of the first voltage to move the reversely charged toner from the charger to the image bearer. The second process (b) includes applying the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. The second process (b) includes applying the charger a sixth voltage having an absolute value larger than the second absolute value of the fourth voltage. The third process (c) includes moving toner having the first polarity from the image bearer to the developing device.

In the present embodiment, an image printing period is defined as a period during which a transfer process is performed but may include a period during which an exposure process and a developing process are performed in addition to the period during which the transfer process is performed. In addition, a non-image printing period is defined as a period during which an image is not printed. The image printing period may be referred to as an image formation period, and the non-image printing period may be referred to as a non-image formation period. In the present embodiment, a direct current bias (a DC bias) is applied to the charger to move the reversely charged toner that is in the transfer residual toner and charged to the polarity opposite to a typical charging polarity of toner to the charger during the image printing period. In the developing device, most of the toner particles are charged to either positive polarity or negative polarity, and the amount of toner particles charged to the other polarity is small. In this specification, the polarity to which most of the toner particles are charged in the developing device is referred to as the typical charging polarity (or a first polarity) of the toner.

Applying an alternate current bias (AC bias) to the charger to print the image may be considered. However, both the positive toner and the negative toner adhered to the charger to which the AC bias is applied. In order to move both of the positive toner and the negative toner from the charger to the image bearer, multiple processes moving the toners are required. As a result, the above-described cleanerless system needs a long time of control to clean the charger and increases the travel distance of the photoconductor. Increasing the travel distance of the photoconductor increases a scraped amount of the surface of the photoconductor and shortens the life of the photoconductor.

In contrast, the DC bias is applied to the charger in the present embodiment during the image printing period to move the reversely charged toner from the image bearer to the charger. Therefore, moving the reversely charged toner from the charger to the image bearer can clean the charger. The above-described structure can shorten the time of control to move the toner from the charger to the image bearer, which prevents the life of the image bearer from shortening. Preventing the life of the image bearer from shortening can reduce a running cost, which can reduce the total cost.

In the cleanerless system of the present embodiment, the transfer residual toner moves from the charger to the developing device via the image bearer during the non-image printing period after the image printing period, and the developing device collects the transfer residual toner. In the present embodiment, performing the above-described first process (a) to the third process (c) causes the developing device to collect the transfer residual toner, and a discharger that eliminates the charge on the surface of the image bearer can be omitted. In one type of cleanerless system, the discharger that eliminates the charge on the surface of the image bearer is used to collect the transfer residual toner to the developing device. The discharger is used to adjust the potential of the surface of the photoconductor in order to move the toner from the charger to the photoconductor. The discharger is also used to adjust the charge of the toner moved from the charger to the photoconductor. The controller in the present embodiment controls a voltage applied to the transferor to adjust the potential of the surface of the photoconductor. As a result, the discharger can be omitted, and thus the number of components and the size and cost of the image forming apparatus can be reduced.

With reference to the drawings, the cleanerless image forming apparatus is described below. The image forming apparatus includes a charging roller as a charger, a developing device including a developing roller, and a photoconductor drum as a photoconductor that is an example of an image bearer.

The image forming apparatus uses a sheet or a recording medium as a transfer medium but may use an intermediate transferor such as an intermediate transfer belt as the transfer medium.

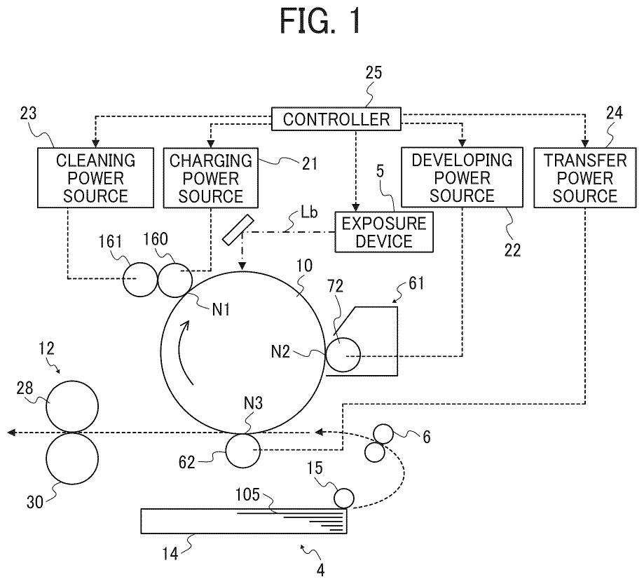

FIG. 1 is a schematic diagram of the image forming apparatus. As illustrated in FIG. 1, the image forming apparatus includes a sheet feeder 4, a registration roller pair 6, a photoconductor drum 10 as the image bearer, a transfer roller 62, and a fixing device 12.

The image forming apparatus further includes a charging power source 21, a developing power source 22, a cleaning power source 23, a transfer power source 24, which supply bias voltages for forming an image, and a controller 25 that is circuitry to control the outputs of these power sources.

The charging power source 21 applies a voltage to a charging roller 160 as the charger, and the voltage applied to the charging roller 160 may be referred to as a charging bias voltage. The developing power source 22 applies a voltage to a developing roller 72 in a developing device 61, and the voltage applied to the developing roller 72 may be referred to as a developing bias voltage. The transfer power source 24 applies a voltage to a transfer roller 62 as a transferor, and the voltage applied to the transfer roller 62 may be referred to as a transfer bias voltage.

The sheet feeder 4 includes a sheet tray 14 and a feed roller 15. The sheet tray 14 accommodates a stack of sheets 105. The feed roller 15 sequentially separates and feeds an uppermost sheet 105 from the stack of sheets 105 accommodated in the sheet tray 14. The sheet is an example of the transfer medium and may be referred to as a recording medium, a recording material, or a medium.

The registration roller pair 6 temporarily stops the uppermost sheet 105 fed by the feed roller 15 to correct the skew of the sheet 105. After correcting the skew of the sheet 105, the registration roller pair 6 sends the sheet 105 to a transfer portion N3 at a timing synchronizing rotation of the photoconductor drum 10, that is, the timing at which a leading edge of a toner image formed on the photoconductor drum 10 meets a certain position of a leading edge of the sheet 105 in a sheet conveyance direction.

Around the photoconductor drum 10, the image forming apparatus includes the charging roller 160 as the charger, the developing device 61 including the developing roller 72, and the transfer roller 62 in an order indicated by an arrow in FIG. 1.

The charging roller 160 and the developing roller 72 are in contact with the photoconductor drum 10. A collection brush 161 (which may be referred to as a brush roller, a cleaning brush, or a cleaner) is in contact with the charging roller 160. The collection brush 161 is an example of a collector.

The charging roller 160 is a contact type charger that contacts the photoconductor drum 10. The contact type charger stably performs pre-charging discharge. The charger to charge the photoconductor drum 10 is not limited to the charging roller 160 and may be a charging brush roller.

The exposure device 5 irradiates and scans the surface of the photoconductor drum 10 between the charging roller 160 and the developing device 61 with an exposure light Lb.

After the photoconductor drum 10 starts rotating, the charging power source 21 applies the charging bias voltage to the charging roller 160, and the charging roller 160 uniformly charges the surface of the photoconductor drum 10 at a charging region N1. Based on image data, the controller 25 controls the exposure device 5 to irradiate the surface of the photoconductor drum 10 with the exposure light Lb to reduce an electric potential on the surface of the photoconductor drum 10 corresponding to an image to be formed to form an electrostatic latent image. The rotation of the photoconductor drum 10 moves the electrostatic latent image to a developing region N2. The developing power source 22 applies the developing bias voltage to the developing roller 72 in the developing device 61.

In the developing region N2, negatively charged toner held on the developing roller 72 is supplied from the developing roller 72 to the photoconductor drum 10 in accordance with the potential difference between the potential of the exposed portion and the developing bias voltage to form a toner image on the photoconductor drum 10. The toner image formed on the photoconductor drum 10 moves to a transfer region N3 at a predetermined timing. The transfer power source 24 applies the transfer bias voltage to the transfer roller 62 to transfer the toner image from the photoconductor drum 10 to the sheet 105 that has entered the transfer region N3.

After the transfer roller 62 transfers the toner image from the photoconductor drum 10 onto the sheet 105, the sheet 105 bearing the toner image is conveyed toward the fixing device 12. A fixing roller 28 and a pressure roller 30 in the fixing device 12 fix the toner image onto the sheet 105. After that, the sheet 105 is ejected and stacked on an output tray. The transfer residual toner remaining on the photoconductor drum 10 without being transferred to the sheet 105 in the transfer region N3 reaches the charging region N1 with the rotation of the photoconductor drum 10. In the charging region N1, the transfer residual toner is charged to a negative polarity by a discharge in a small gap between the photoconductor drum 10 and the charging roller 160 to which the charging bias voltage is applied and is returned to the developing region N2.

In the developing region N2, the transfer residual toner is moved onto the developing roller 72 by a potential difference between the developing bias voltage and a potential of a non-exposure portion that is not exposed by the exposure device 5 and is collected into the developing device 61.

In the charging region N1, it is difficult to completely charge the transfer residual toner to the negative polarity, and the toner having the positive polarity adheres to the charging roller 160. Accordingly, it is preferable to use the collection brush 161 for scraping off the contamination of the charging roller 160. The cleaning power source 23 applies a cleaning bias voltage to the collection brush 161. Mechanical scraping and the potential difference between the collection brush 161 and the charging roller 160 cleans the toner having the positive polarity and adhering to the charging roller 160. Using the collection brush 161 can clean the charging roller 160 more.

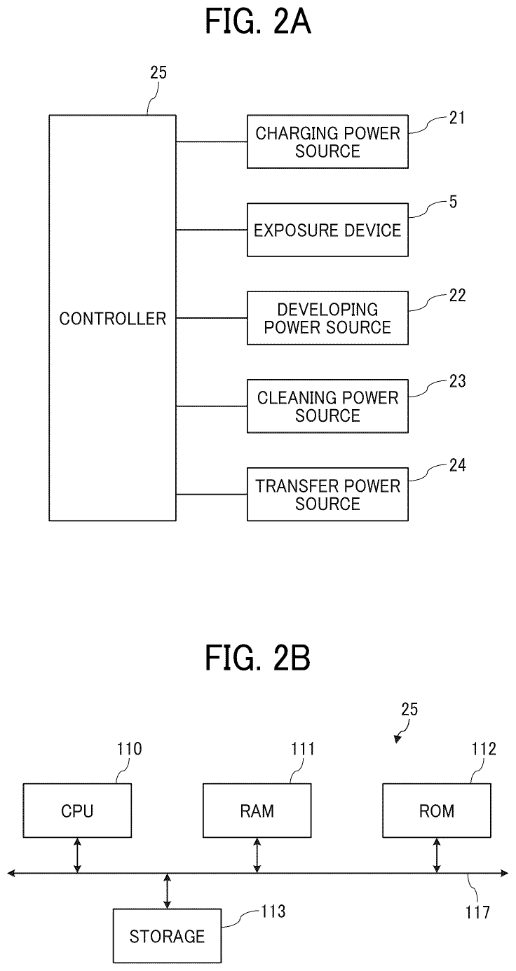

FIG. 2A is a block diagram of a hardware configuration of the controller 25 and power sources. The controller 25 includes a central processing unit (CPU) as a central element to perform arithmetic processing and memories such as a read-only memory (ROM) and a random-access memory (RAM). The RAM stores detection results of sensors and calculation results, and the ROM stores control programs and data tables obtained in advance. The controller 25 controls, for example, the charging power source 21, the developing power source 22, the cleaning power source 23, the transfer power source 24, and the exposure device 5. The controller 25 controls ON and OFF of the output of the power sources and output values of the power sources.

FIG. 2B is a block diagram of a hardware configuration of the controller 25.

In the controller 25, a central processing unit (CPU) 110, a random-access memory (RAM) 111, a read-only memory (ROM) 112, and a storage 113 are connected to each other via a bus 117.

The CPU 110 is an arithmetic device and controls the overall operation of the image forming apparatus. The RAM 111 is a volatile storage medium that allows data to be read and written at high speed. When the CPU 110 processes data, the RAM 111 is used as a working area of the CPU 110. The ROM 112 is a read-only non-volatile storage medium and stores programs such as firmware.

The storage 113 is a non-volatile storage medium that allows data to be read and written, and that stores, for example, an operating system (OS), various control programs, and application programs. The storage 113 is, for example, a solid-state drive (SSD) or a hard disk drive (HDD).

In the image forming apparatus of the present embodiment, the developing device collects the transfer residual toner remaining on the image bearer. The image forming apparatus of the present embodiment is configured not to use a cleaner such as a cleaning blade to clean the image bearer which is also referred to as an electrostatic latent image bearer or a photoconductor. The above-described image forming apparatus has an advantage of downsizing the image forming apparatus.

In the following description, the cleanerless system is described as a system not including the cleaner cleaning the image bearer. The cleanerless system may include a cleaner cleaning the charger or a cleaner cleaning the intermediate transfer belt. In addition, the cleanerless system may include a system that temporarily collects the transfer residual toner on the image bearer.

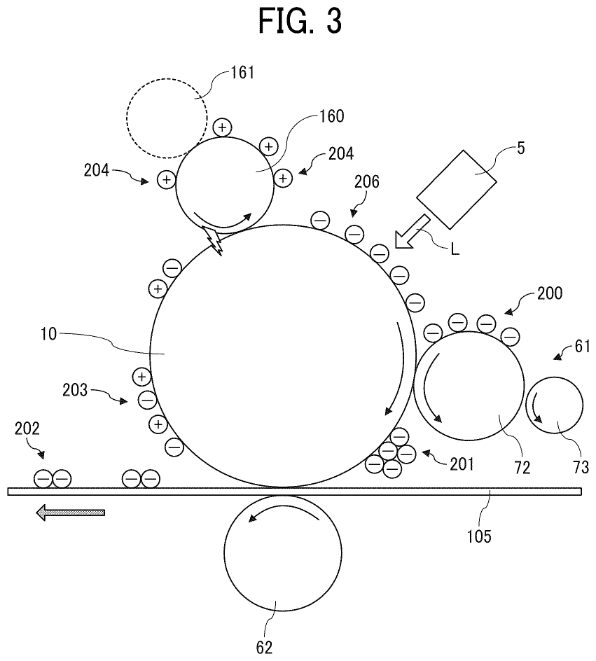

The basic configuration and operation of the cleanerless image forming apparatus are described with reference to FIG. 3. FIG. 3 is a schematic diagram illustrating an example of an image forming process. The image forming apparatus in FIG. 3 includes the charging roller as the charger. In the following description, the charging roller is described as an example of the charger.

The charging roller 160 uniformly charges the photoconductor drum 10 as the image bearer. The charging roller 160 in the present embodiment is disposed to be in contact with the photoconductor drum 10, and, for example, a direct current (DC) voltage is applied to charge the photoconductor drum 10. In this embodiment, a contact type DC charging system is employed.

The exposure device 5 exposes the photoconductor drum 10 to exposure light L to form the electrostatic latent image on the photoconductor drum 10. The exposure device 5 is not particularly limited to a specified system. For example, a light-emitting diode (LED) is used.

The developing device 61 includes the developing roller 72 that is one example of a developer bearer. The developing power source 22 controlled by the controller 25 applies the developing bias voltage to the developing roller 72, and the developing roller 72 supplies toner 200 to the photoconductor drum 10. As a result, the toner image, which is also referred to as a visible image is formed on the photoconductor drum 10. The developing device 61 may include, for example, a stirring roller 73 to stir the toner in the developing device 61. The rotation direction of the stirring roller 73 can be appropriately selected, and the stirring roller 73 may be in contact with the developing roller 72 or may not be in contact with the developing roller 72.

The transfer roller 62 transfers the toner image on the photoconductor drum 10 onto the sheet 105.

The above configuration is a basic configuration of the cleanerless image forming apparatus. The cleanerless image forming apparatus does not include a cleaner such as the cleaning blade to clean the photoconductor drum 10 after the transfer process.

In the example illustrated in FIG. 3, the developing power source applies −300 V to the developing roller 72, and the charging power source applies −1200 V to the charging roller 160, but the present disclosure is not limited to this. After the charge is eliminated from the photoconductor drum 10 by the transfer roller 62, the surface potential of the photoconductor drum 10 is, for example, about −100 V. After the charging roller 160 charges the surface of the photoconductor drum 10, the surface potential of the photoconductor drum 10 is, for example, about −500 V.

The image forming apparatus of the present embodiment may include the collection brush 161 as the collector that collects the toner on the charging roller 160.

The following describes an example of the flow of the toner in the example illustrated in FIG. 3. For the sake of explanation, the reference numerals of the toners in FIG. 3 are changed depending on the positions and states of the toners.

The developing roller 72 bears the toner 200, and the toner 200 borne by the developing roller 72 is supplied to the photoconductor drum 10. The toner supplied to the photoconductor drum 10 becomes toner 201 and forms the toner image as the visible image in accordance with the electrostatic latent image. The toner 201 on the photoconductor drum 10 is transferred onto the sheet 105. Toner 202 transferred to the sheet 105 is fixed to the sheet 105 in a later process.

The toner that has not been transferred in the transfer process remains on the photoconductor drum 10 as transfer residual toner 203. The transfer residual toner 203 adheres to the charging roller 160 at a contact portion at which the photoconductor drum 10 contacts the charging roller 160 and in the vicinity of the contact portion. A part of the transfer residual toner 203 does not adhere to the charging roller 160 and is referred to as toner 206. The toner 206 remains on the photoconductor drum 10. The developing roller 72 collects the toner 206, which is described below.

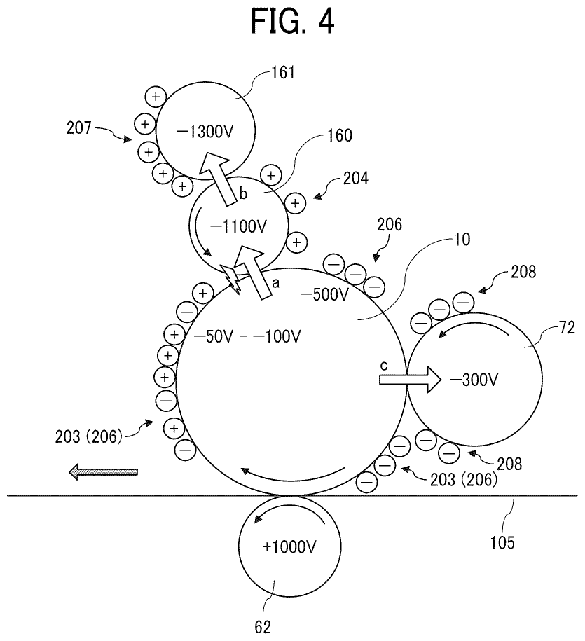

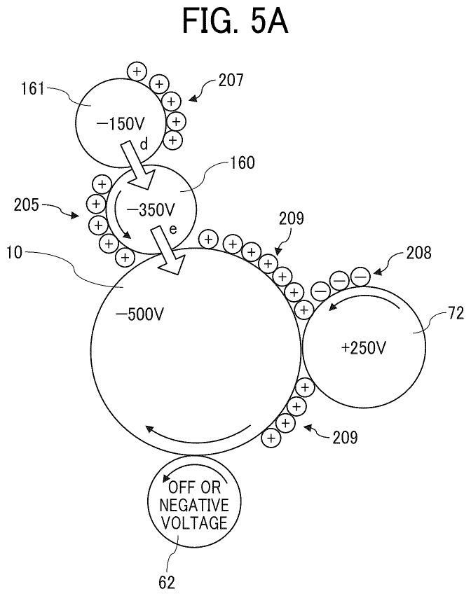

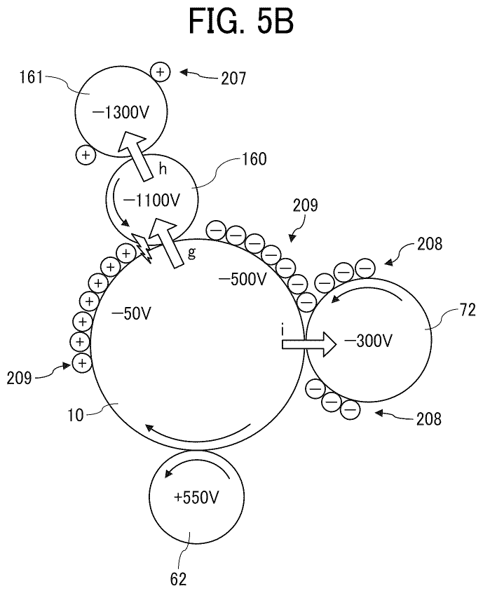

The following describes an example of a method to collect the transfer residual toner in the cleanerless image forming apparatus with reference to FIGS. 4, 5A and 5B.

FIG. 4 is a schematic diagram illustrating processes during printing (in other words, during the image formation period or the image printing period) in the cleanerless image forming apparatus of FIG. 3. In this example, the image printing period is defined as a period in which the transfer process is performed. The non-image printing period is a period other than the image printing period and includes, for example, a sheet interval in continuous printing, a start-up time of the image forming apparatus for preparing for printing, and a shutdown time of the image forming apparatus after printing is finished. Image printing is not performed in the non-image printing period. The image printing is not limited to printing characters and includes forming images such as symbols, pictures, and patterns.

As described with reference to FIG. 3, the toner that has not been transferred in the transfer process remains on the photoconductor drum 10 as the transfer residual toner 203. FIG. 4 illustrates the transfer residual toner 203 remaining on the photoconductor drum 10 downstream of the transfer roller 62 in the rotation direction of the photoconductor drum 10.

The position at which the transfer roller 62 faces the photoconductor drum 10 is referred to as a transfer position. To transfer the toner image to the sheet 105 passing through the transfer position, for example, the transfer power source applies a voltage of +1000 V to the transfer roller 62. Applying a voltage of +1000 V to the transfer roller 62 after the sheet 105 passes through the transfer position eliminates the charge on the surface of the photoconductor drum 10. For example, the transfer roller 62 reduces the absolute value of the surface potential of a printed portion on the photoconductor drum 10 to −50 V and the absolute value of the surface potential of a blank portion on the photoconductor drum 10 to −100 V. Reducing the absolute value of the surface potential of the photoconductor drum 10 as described above increases the potential difference between the charging roller 160 and the photoconductor drum 10 and causes the discharge between the charging roller 160 and the photoconductor drum 10 including the printed portion and the blank portion, which is referred to as the pre-charging discharge. The pre-charging discharge charges the photoconductor drum 10 to, for example, −500 V. In FIG. 4, the discharge is schematically illustrated.

The pre-charging discharge negatively charges the transfer residual toner 203, which generates the toner 206 in FIG. 4. As a result, the pre-charging discharge generates negatively charged toner and minute positively charged toner in the transfer residual toner 203. The minute positively charged toner of the transfer residual toner 203 adheres to the charging roller 160 at the position at which the charging roller 160 contacts the photoconductor drum 10 (or in the vicinity of the position). The toner adhering to the charging roller 160 is illustrated as toner 204 in FIG. 4.

A white arrow a in FIG. 4 schematically indicates that the transfer residual toner 203 on the photoconductor drum 10 adheres to the charging roller 160. In other words, the transfer residual toner 203 on the photoconductor drum 10 moves to the charging roller 160 or is collected by the charging roller 160.

In the present embodiment, the controller 25 controls the charging power source 21 to apply the DC bias to the charging roller 160 as the charger during the image printing period to perform a first collection operation. The transfer residual toner remaining on the image bearer after the transfer process includes reversely charged toner that is charged to the polarity (for example, positive) opposite to the typical charging polarity as the first polarity (for example, negative) of the toner. In this specification, the polarity opposite the first polarity is also referred to as a second polarity. Applying the DC bias to the charging roller 160 moves the reversely charged toner to the charging roller 160. As a result, the first collection operation performs a first collection process. As illustrated in FIG. 4, the charging roller 160 in this example collects the positive toner.

The image forming apparatus of the present embodiment includes the collection brush 161 that collects the toner adhering to the charging roller 160. The collection brush 161 collects the positively charged toner 204 adhering to the charging roller 160. A white arrow b in FIG. 4 schematically indicates that the collection brush 161 collects the toner 204 on the charging roller 160. In other words, the toner 204 on the charging roller 160 moves to the collection brush 161. A collection bias is applied to the collection brush 161. The value of the collection bias can be appropriately selected.

The negatively charged toner of the transfer residual toner 203 on the photoconductor drum 10 does not adhere to the charging roller 160 and remains on the photoconductor drum 10. This toner is illustrated as the toner 206 in FIG. 4. Note that the transfer residual toner includes the toner 203 and the toner 206.

The toner 206 remaining on the photoconductor drum 10 is collected by the developing roller 72. The toner collected by the developing roller 72 is illustrated as toner 208 in FIG. 4. In other words, the toner 206 remaining on the photoconductor drum 10 moves to the developing roller 72. The toner 206 on the photoconductor drum 10 faces the developing roller 72 and moves to the developing roller 72 due to a potential difference between the photoconductor drum 10 and the developing roller 72. A white arrow c in FIG. 4 schematically indicates that the toner 206 on the photoconductor drum 10 is collected by the developing roller 72.

In order to collect the toner by the developing roller 72 as described above, for example, a method of adjusting the potential of each member is used, but the present disclosure is not limited to this. One example of the potentials of members is as follows. The surface potential of the photoconductor drum 10 after the charge is eliminated from the photoconductor drum 10 (in other words, after passing through the transfer position) is −50 V to −100 V, the potential of the charging roller 160 is −1100 V that is an example of a first voltage having a first absolute value of the charger to perform the first collection operation, the potential of the collection brush 161 is −1300 V, the surface potential of the photoconductor drum 10 after the charging roller charges the photoconductor drum 10 is −500 V, and the potential of the developing roller 72 is −300 V. In FIG. 4, the above-described potentials are illustrated, but the potentials are not limited to these.

The following describes an example of the movement of the toner and the toner collection during a shutdown process of the image forming apparatus with reference to FIGS. 5A and 5B. The period during the shutdown process is defined as a part of the non-image printing period and a period to perform predetermined operations after the printing (that is, the image forming operation) ends.

In the present embodiment, the controller 25 performs a second collection operation to move the transfer residual toner that has moved to the charging roller 160 from the charging roller 160 to the photoconductor drum 10 and the developing roller 72 in this order during the non-image printing period. In other words, the controller 25 performs the second collection operation during the non-image printing period to move the transfer residual toner moved to the charging roller 160 from the charging roller 160 to the developing roller 72 via the photoconductor drum 10. As a result, the second collection operation performs a second collection process. The second collection operation includes the above-described first process (a) to the third process (c). As described with reference to FIG. 4, the positively charged toner of the transfer residual toner 203 (and the toner 206) that the pre-charging discharge cannot negatively charge adheres to the charging roller 160 and is collected by the collection brush 161. Since this collection is repeated during printing, the positively charged toner is accumulated on the collection brush 161 and becomes toner 207.

During the shutdown process of the image forming apparatus, adjusting the potential difference between the collection brush 161 and the charging roller 160 moves the minute positively charged toner 207 to the charging roller 160. This is indicated by an arrow d in FIG. 5A. Moving the toner from the collection brush 161 to the charging roller 160 may be referred to as discharging the toner.

Toner 205 moved to the charging roller 160 is moved to the photoconductor drum 10 by the potential difference between the charging roller 160 and the photoconductor drum 10. This is indicated by a white arrow e in FIG. 5A. The moved toner is illustrated as toner 209 in FIG. 5A. Moving the toner from the charging roller 160 to the photoconductor drum 10 may be referred to as discharging the toner.

The positively charged toner 209 on the photoconductor drum 10 is not collected by the developing roller 72 and passes through the developing roller 72 as it is. Further, the toner 209 passes through the transfer roller 62. As a result, the positively charged toner 209 exists on the photoconductor drum 10 during the shutdown process of the image forming apparatus.

In FIGS. 4, 5A, and 5B, the above-described toners 203, 206, and 209 are illustrated on the photoconductor drum 10. All of these are considered as the transfer residual toner. After the transfer residual toner 203 is collected by the collection brush 161, the toner moves to the photoconductor drum 10 again as the toner 209. Such toner may be also included in the transfer residual toner.

In order to move the toner as in the example illustrated in FIG. 5A, for example, the potentials of members are adjusted, but the present disclosure is not limited to this. One example of the potentials of members is as follows. The potential of the collection brush 161 is −150 V, the potential of the charging roller 160 is −350 V, the surface potential of the photoconductor drum 10 is −500 V, and the potential of the developing roller 72 is +250 V. FIG. 5A illustrates the above-described potentials, but the potentials are not limited to this example.

In FIG. 5A, “OFF OR NEGATIVE VOLTAGE” is written in the transfer roller 62. This represents an initial part of the first process (a) described above. In the first process (a), the controller 25 controls the transfer power source 24 to stop applying the voltage to the transfer roller 62 (OFF) or apply a voltage having a polarity opposite that of the voltage applied to the transfer roller 62 during the image printing period to the transfer roller 62. In other words, the controller 25 as the circuitry performs the initial part of the first process (a) to control the transfer power source 24 to stop applying the voltage to the transfer roller 62 or to apply the transfer roller 62 a second voltage having the first polarity opposite the second polarity of a third voltage applied to the transfer roller 62 during the image printing period. After the controller 25 completes the transfer process to transfer the image to the transfer medium, the controller 25 controls the transfer power source 24 to stop applying the voltage to the transfer roller 62 (OFF) or apply the voltage having the polarity opposite to that of the voltage applied to the transfer roller 62 during the image printing period to the transfer roller 62. Completing the transfer process to transfer the image to the transfer medium means the end of the image printing period. As illustrated in FIG. 4, since a positive voltage (for example, +1000 V) is applied to the transfer roller 62 during the image printing period as an example of the third voltage, the voltage having the polarity opposite to that of the voltage applied to the transfer roller 62 during the image printing period is a negative voltage.

In the example illustrated in FIG. 5A, applying −350 V to the charging roller 160 represents the latter part of the first process (a). In the latter part of the first process (a), the controller 25 controls the charging power source 21 so that the absolute value of the voltage applied to the charging roller 160 after the image printing period is smaller than the absolute value of the voltage applied to the charging roller 160 during the image printing period. For example, the charging power source 21 applies −1100 V to the charging roller 160 during the image printing period as illustrated in FIG. 4 and applies −350 V to the charging roller 160 after the image printing period as the voltage having the smaller absolute value than the absolute value of −1100 V as illustrated in FIG. 5A. In other words, the controller 25 performs the latter process of the first process (a) to control the charging power source 21 to apply the charging roller 160 −350 V as an example of the fourth voltage having 350 as an example of the second absolute value smaller than 1100 as an example of the first absolute value of the first voltage. The above-described control moves the reversely charged toner (the positive toner in this example) charged to the polarity opposite the typical charging polarity of the toner from the charging roller 160 to the photoconductor drum 10.

The following describes how the toner on the photoconductor drum 10 is collected during the shutdown process with reference to FIG. 5B. FIG. 5B illustrates a situation subsequent to FIG. 5A.

As illustrated in FIG. 5B, the controller 25 controls the transfer power source 24 to apply +550V to the transfer roller 62 at a predetermined timing. As a result, discharge occurs due to the potential difference between the potential of the transfer roller 62 and the surface potential (for example, −500 V) of the photoconductor drum 10, which eliminates the charge on the photoconductor drum 10. Eliminating the charge on the photoconductor drum 10 increases the potential difference between the charging roller 160 and the photoconductor drum 10 and causes the discharge between the charging roller 160 and the photoconductor drum 10. In FIG. 5B, the discharge is schematically illustrated.

The above-described discharge negatively charges the toner 209. As described with reference to FIG. 4, some of the toner 209 is not negatively charged but remains positively charged. Such toner adheres to the charging roller 160 and is collected by the collection brush 161. Such toner moves as indicated by white arrows g and h in FIG. 5B.

The toner 209 negatively charged by the discharge remains on the photoconductor drum 10 without moving to the charging roller 160. The negatively charged toner 209 is collected by the developing roller 72 to which the developing bias voltage is applied and moves as indicated by a white arrow i in FIG. 5B. The toner collected by the developing roller 72 is illustrated as toner 208 in FIG. 5B.

In order to move the toner as in the example illustrated in FIG. 5B, for example, the potentials of members are adjusted, but the present disclosure is not limited to this. One example of the potentials of members is as follows. The potential of the transfer roller 62 is +550 V, the potential of the collection brush 161 is −1300 V, the potential of the charging roller 160 is −1100 V, the surface potential of the photoconductor drum 10 after passing through the transfer position is −50 V, the surface potential of the photoconductor drum 10 after the charging roller charges the photoconductor drum 10 is −500 V, and the potential of the developing roller 72 is −300 V. FIG. 5B illustrates the above-described potentials, but the potentials are not limited to this example.

In the example illustrated in FIG. 5B, applying +550 V to the transfer roller 62 represents an initial part of the second process (b). In the initial part of the second process (b), the controller 25 controls the transfer power source 24 to apply a voltage having the same polarity as the voltage applied to the transfer roller 62 during the image printing period to the transfer roller 62. In addition, the controller 25 controls the transfer power source 24 to apply the voltage so that the absolute value of the surface potential of the photoconductor drum 10 after passing through the position facing the transfer roller 62 is smaller than the absolute value of the surface potential of the photoconductor drum 10 before passing through the position facing the transfer roller 62. Since the voltage applied to the transfer roller 62 during the image printing period is +1000 V in FIG. 4, the positive voltage having the same polarity as the voltage applied to the transfer roller 62 during the image printing period is applied to the transfer roller 62 in FIG. 5B.

In addition, the transfer power source 24 applies, for example, +550 V to the transfer roller 62 as a voltage having a smaller absolute value than the absolute value of +1000 V. As a result, the charge on the photoconductor drum 10 can be eliminated.

As illustrated in FIG. 2, the surface potential of the photoconductor drum 10 before passing through the position facing the transfer roller 62 (which may be referred to as the transfer position) is, for example, −500 V, and the surface potential of the photoconductor drum 10 after passing through the transfer position is, for example, −50 V. The charge on the photoconductor drum 10 is eliminated. In other words, the controller 25 performs the initial part of the second process (b) to control the transfer power source 24 to apply the transfer roller 62 a fifth voltage (for example +550 V) having the second polarity of the third voltage (for example, +1000 V) that causes a third absolute value of a first potential (for example, −50 V) on a surface of the photoconductor drum 10 downstream of the transfer position to be smaller than a fourth absolute value of a second potential (for example, −500 V) on the surface of the photoconductor drum 10 upstream of the transfer position in the rotation direction of the photoconductor drum 10.

In the above first process (a), the control to apply the voltage to the transfer roller 62 includes stopping applying the voltage to the transfer roller 62.

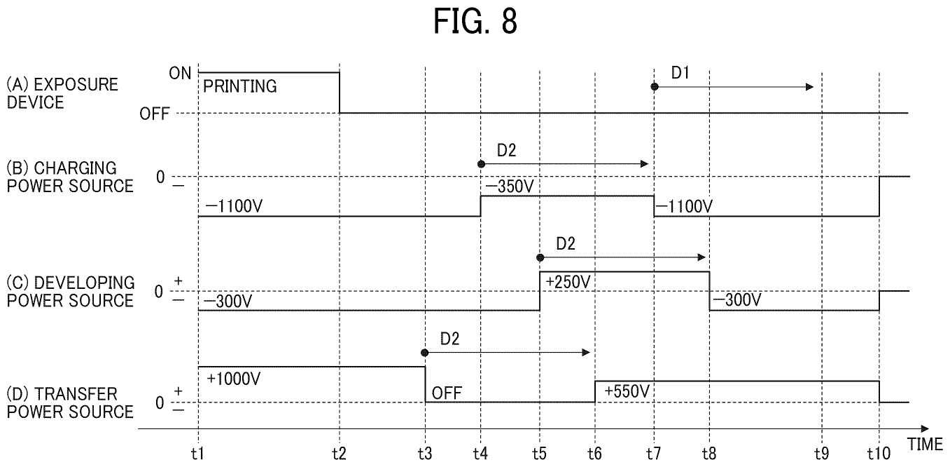

The timing at which +550V is applied to the transfer roller 62 can be selected as appropriate. For example, the controller 25 controls the transfer power source 24 to switch the voltage applied to the transfer roller 62 to +550 V immediately before the toner discharged from the charging roller 160 passes through the transfer roller 62. The transfer roller changes the surface potential of the photoconductor drum 10 from −500 V to −50 V. However, the potential difference between the surface potential of the photoconductor drum 10 and the transfer roller 62 keeps the positive toner attracted to the photoconductor drum 10 and prevents the toner from moving to the transfer roller 62. For example, in FIG. 8 described below, the controller 25 controls the transfer power source 24 to turn off the transfer bias at t3 in FIG. 8, waits until the charging roller 160 rotates three times, and controls the transfer power source 24 to apply +550 V to the transfer roller 62 at t6 in FIG. 8.

In the example illustrated in FIG. 5B, applying a voltage of −1100 V to the charging roller 160 represents the latter part of the second process (b). In the latter part of the second process (b), the controller 25 controls the charging power source 21 so that the absolute value of the voltage applied to the charging roller 160 is larger than the absolute value of the voltage applied to the charging roller 160 in the above-described first process (a). In other words, the controller 25 performs the latter part of the second process (b) to control the charging power source 21 to apply the charging roller −1100 V as an example of a sixth voltage having an absolute value larger than 1100 as an example of the second absolute value of the fourth voltage. As a result, the discharge occurs between the charging roller 160 and the photoconductor drum 10. For example, the charging power source 21 applies −350 V to the charging roller 160 in the first process (a) as illustrated in FIG. 5A and applies −1100 V to the charging roller 160 as the voltage having the larger absolute value than the absolute value of −350 V as illustrated in FIG. 5B. The above-described control causes the pre-charging discharge between the charging roller 160 and the photoconductor drum 10. The above-described pre-charging discharge charges the reversely charged toner (the positive toner 209 in this example) that is moved onto the photoconductor drum 10 in the above-described first process (a) to the typical charging polarity of the toner (negative in this example).

Preferably, the controller 25 starts the latter part of the second process (b) after starting the initial part of the second process (b). In the example of the timing chart illustrated in FIG. 8 described below, the controller 25 starts the initial part of the second process (b) at t6 and starts the latter part of the second process (b) at t7 after t6. This is because the charging position is located downstream of the transfer position in the rotation direction of the photoconductor drum 10.

As indicated by a white arrow i in FIG. 5B, the developing roller 72 collects the negatively charged toner 209, which represents the above-described third process (c). The above-described third process (c) moves the typically charged toner (the negative toner in this example) charged to the typical charging polarity of the toner in the second process (b) to the developing roller 72. In other words, the controller 25 performs the third process (c) to control the developing device to move toner having the first polarity from the photoconductor drum as the image bearer to the developing device.

As described above, the controller 25 performs the first process (a) to the third process (c) to move the transfer residual toner from the charging roller 160 to the developing roller 72 via the photoconductor drum 10 during the non-image printing period after the image printing period. The above-described configuration can eliminate the charge on the surface of the photoconductor drum 10 without using a discharging device that eliminates the charge on the surface of the photoconductor drum 10.

The controller 25 adjusts the potential of each member. The controller 25 controls the charging power source 21, the developing power source 22, the cleaning power source 23, and the transfer power source 24 to adjust the potentials of the photoconductor drum 10, the transfer roller 62, the developing roller 72, the charging roller 160, and the collection brush 161. The controller 25 includes the CPU.

The voltage applied to each member (at least the collection brush 161 as the collector) to move the transfer residual toner is not limited to the DC voltage and may be a voltage obtained by superimposing an AC voltage on the DC voltage. The above-described voltage obtained by superimposing the AC voltage on the DC voltage gives an effect that the transfer residual toner is vibrated and easily moved. Preferably, a voltage obtained by superimposing an AC voltage on a DC voltage is applied to the collection brush 161 to discharge the transfer residual toner. In this case, the transfer residual toner can be more easily moved from the collection brush 161.

During the image printing period, the charging power source 21 applies the direct current voltage (the DC bias) to the charging roller 160. In contrast, during the non-image printing period, the charging power source 21 may apply the alternating current voltage (the AC bias) to the charging roller 160. For example, applying the voltage obtained by superimposing the AC voltage on the DC voltage to a charging brush roller as the charger to move the toner from the charging brush roller to the photoconductor gives the effect that the transfer residual toner is vibrated and easily moved.

The image forming apparatus may employ the above-described cleanerless system. The above-described cleanerless system controls the charging characteristics of the toner and moves and collects the toner by an electric field in each process. As a result, the charging roller 160 and the collection brush 161 can be prevented from being contaminated with toner.

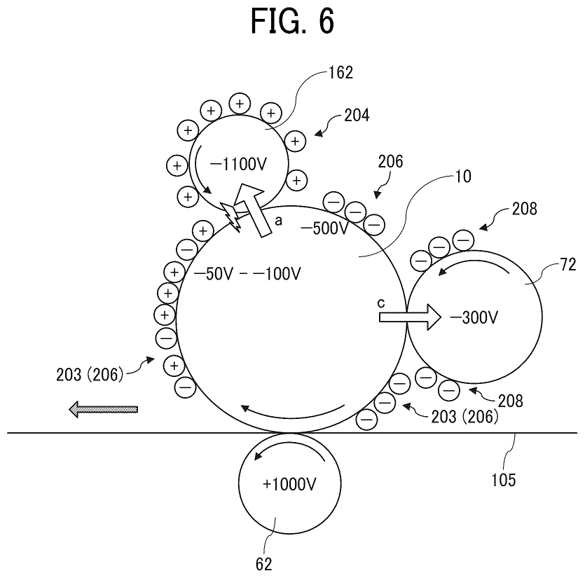

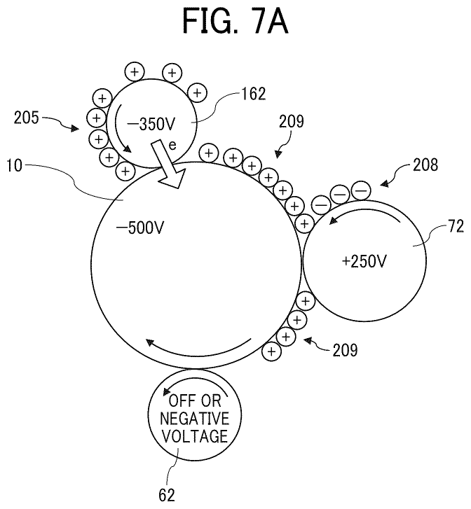

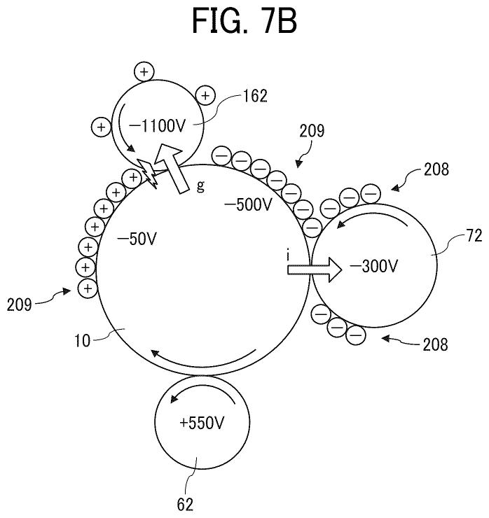

The following describes another example of the method to collect the transfer residual toner in the cleanerless image forming apparatus with reference to FIGS. 6, 7A, and 7B. Descriptions of matters similar to the above are omitted.

The image forming apparatus in this example includes a charging brush roller 162 as the charger. The charging brush roller 162 can charge the photoconductor drum 10 and collect the transfer residual toner. The charging brush roller 162 may be formed by winding a fiber brush around a roller base or by implanting fibers in the roller base. According to this example, the cleanerless system can be obtained at a lower cost. The method of collecting the transfer residual toner in this example is the same as the above-described method of discharging the transfer residual toner from the charging roller 160.

FIG. 6 is a schematic diagram illustrating processes during printing (in other words, during the image formation period or the image printing period) in the cleanerless image forming apparatus including the charging brush roller 162.

To transfer the toner image to the sheet 105 passing through the transfer position, for example, the transfer power source applies a voltage of +1000 V to the transfer roller 62. Applying a voltage of +1000V to the transfer roller 62 after the sheet 105 passes through the transfer position eliminates the charge on the surface of the photoconductor drum 10. For example, the transfer roller 62 reduces the absolute value of the surface potential of a printed portion on the photoconductor drum 10 to −50 V and the absolute value of the surface potential of a blank portion on the photoconductor drum 10 to −100 V. Reducing the absolute value of the surface potential of the photoconductor drum 10 as described above increases the potential difference between the charging brush roller 162 and the photoconductor drum 10 and causes the discharge between the charging brush roller 162 and the photoconductor drum 10 including the printed portion and the blank portion, which is referred to as the pre-charging discharge. Pre-charging discharge charges the photoconductor drum 10 to, for example, −500 V. In FIG. 6, the discharge is schematically illustrated.

The pre-charging discharge negatively charges the transfer residual toner 203. As a result, the pre-charging discharge generates negatively charged toner and minute positively charged toner in the transfer residual toner 203. The minute positively charged toner of the transfer residual toner 203 adheres to the charging brush roller 162 at the position at which the charging brush roller 162 contacts the photoconductor drum 10 (or in the vicinity of the position). The toner adhering to the charging brush roller 162 is illustrated as toner 204 in FIG. 6.

A white arrow a in FIG. 6 schematically indicates that the transfer residual toner 203 on the photoconductor drum 10 adheres to the charging brush roller 162.

The charging brush roller 162 used as the charger in this example can accumulate the transfer residual toner in the brush. After the transfer residual toner is adhered to the surface of the charging roller, the charging roller cannot charge the photoconductor drum 10 well. The charging brush roller 162 can accumulate the transfer residual toner and charge the photoconductor drum 10 until the brush cannot store the transfer residual toner.

The negatively charged toner of the transfer residual toner 203 on the photoconductor drum 10 does not adhere to the charging brush roller 162 and remains on the photoconductor drum 10. This toner is illustrated as the toner 206 in FIG. 6. Note that the transfer residual toner includes the toner 203 and the toner 206.

The toner 206 remaining on the photoconductor drum 10 is collected by the developing roller 72. The toner collected by the developing roller 72 is illustrated as toner 208 in FIG. 6. The toner 206 on the photoconductor drum 10 faces the developing roller 72 and moves to the developing roller 72 due to a potential difference between the photoconductor drum 10 and the developing roller 72. A white arrow c in FIG. 6 schematically indicates that the toner 206 on the photoconductor drum 10 is collected by the developing roller 72.

In order to collect the toner by the developing roller 72 as described above, for example, a method of adjusting the potential of each member is used, but the present disclosure is not limited to this. One example of the potentials of members is as follows. The surface potential of the photoconductor drum 10 after the charge is eliminated from the photoconductor drum 10 (in other words, after passing through the transfer position) is −50 V to −100 V, the potential of the charging brush roller 162 is −1100 V that is an example of the first voltage having the first absolute value of the charger to perform the first collection operation, the surface potential of the photoconductor drum 10 after the charging roller charges the photoconductor drum 10 is −500 V, and the potential of the developing roller 72 is −300 V. In FIG. 6, the above-described potentials are illustrated, but the potentials are not limited to these.

The following describes an example of the movement of the toner and the toner collection during a shutdown process of the image forming apparatus with reference to FIGS. 7A and 7B. The period during the shutdown process is defined as a part of the non-image printing period and the period to perform predetermined operations after the printing (that is, the image forming operation) ends.

As described with reference to FIG. 6, the positively charged toner of the transfer residual toner 203 (and the toner 206) that the pre-charging discharge cannot negatively charge adheres to the charging brush roller 162 and is collected in the charging brush roller 162. Since this collection is repeated during printing, the positively charged toner is accumulated on the charging brush roller 162 and becomes toner 207.

During the shutdown process, the potential difference between the charging brush roller 162 and the photoconductor drum 10 moves the toner 205 accumulated in the charging brush roller 162 to the photoconductor drum 10. This is indicated by a white arrow e in FIG. 7A. The moved toner is illustrated as toner 209 in FIG. 7A.

The positively charged toner 209 on the photoconductor drum 10 is not collected by the developing roller 72 and passes through the developing roller 72 as it is. Further, the toner 209 passes through the transfer roller 62. As a result, the positively charged toner 209 exists on the photoconductor drum 10 during the shutdown process of the image forming apparatus.

In order to move the toner as in the example illustrated in FIG. 7A, for example, the potentials of members are adjusted, but the present disclosure is not limited to this. One example of the potentials of members is as follows. The potential of the charging brush roller 162 is −350 V, the surface potential of the photoconductor drum 10 is −500 V, and the potential of the developing roller 72 is +250 V. FIG. 7A illustrates the above-described potentials, but the potentials are not limited to this example.

The following describes how the toner on the photoconductor drum 10 is collected during the shutdown process with reference to FIG. 7B. FIG. 7B illustrates a situation subsequent to FIG. 7A.

As illustrated in FIG. 7B, the controller 25 controls the transfer power source 24 to apply +550V to the transfer roller 62 at a predetermined timing. As a result, discharge occurs due to the potential difference between the potential of the transfer roller 62 and the surface potential (for example, −500 V) of the photoconductor drum 10, which eliminates the charge on the photoconductor drum 10. Eliminating the charge on the photoconductor drum 10 increases the potential difference between the charging brush roller 162 and the photoconductor drum 10 and causes the discharge between the charging brush roller 162 and the photoconductor drum 10. In FIG. 7B, the discharge is schematically illustrated.

The timing at which +550V is applied to the transfer roller 62 can be selected as appropriate. For example, the controller 25 controls the transfer power source 24 to switch the voltage applied to the transfer roller 62 to +550 V immediately before the toner discharged from the charging brush roller 162 passes through the transfer roller 62. The transfer roller changes the surface potential of the photoconductor drum 10 from −500 V to −50 V. However, the potential difference between the surface potential of the photoconductor drum 10 and the transfer roller 62 keeps the positive toner attracted to the photoconductor drum 10 and prevents the toner from moving to the transfer roller 62. For example, in FIG. 8 described below, the controller 25 controls the transfer power source 24 to turn off the transfer bias at t3 in FIG. 8, waits until the charging roller 160 rotates three times, and controls the transfer power source 24 to apply +550 V to the transfer roller 62 at t6 in FIG. 8.

The above-described discharge negatively charges the toner 209. As described with reference to FIG. 6, some of the toner 209 is not negatively charged but remains positively charged. Such toner adheres to the charging brush roller 162 and is collected in the charging brush roller 162. Such toner moves as indicated by the white arrow g in FIG. 7B.

The toner 209 negatively charged by the discharge remains on the photoconductor drum 10 without moving to the charging brush roller 162. The negatively charged toner 209 is collected by the developing roller 72 to which the developing bias voltage is applied and moves as indicated by a white arrow i in FIG. 7B. The toner collected by the developing roller 72 is illustrated as toner 208 in FIG. 7B.

In order to move the toner as in the example illustrated in FIG. 7B, for example, the potentials of members are adjusted, but the present disclosure is not limited to this. One example of the potentials of members is as follows. The potential of the transfer roller 62 is +550 V, the potential of the charging brush roller 162 is −1100 V, the surface potential of the photoconductor drum 10 after the charge is eliminated is −50 V, the surface potential of the photoconductor drum 10 after the charging brush roller charges the photoconductor drum 10 is −500 V, and the potential of the developing roller 72 is −300 V. FIG. 7B illustrates the above-described potentials, but the potentials are not limited to this example.

The voltage applied to each member to move the transfer residual toner is not limited to a DC voltage and may be a voltage obtained by superimposing an AC voltage on the DC voltage. The above-described voltage obtained by superimposing the AC voltage on the DC voltage gives the effect that the transfer residual toner is vibrated and easily moved. Preferably, at least in the second collection process, the voltage obtained by superimposing the AC voltage on the DC voltage is applied to the charging brush roller. In this case, the transfer residual toner can be more easily moved from the charging brush roller 162.

The image forming apparatus may employ the above-described cleanerless system. The above-described cleanerless system controls the charging characteristics of the toner and moves and collects the toner by an electric field in each process. As a result, the charging brush roller 162 can be prevented from being contaminated with toner.

The controller 25 in this example also performs the above first process (a) to the third process (c).

In FIG. 7A, “OFF OR NEGATIVE VOLTAGE” is written in the transfer roller 62. This represents the initial part of the first process (a) described above. In the first process (a), the controller 25 controls the transfer power source 24 to stop applying the voltage to the transfer roller 62 (OFF) or apply a voltage having a polarity opposite to that of the voltage applied to the transfer roller 62 during the image printing period to the transfer roller 62. In other words, the controller 25 as the circuitry performs the initial part of the first process (a) to control the transfer power source 24 to stop applying the voltage to the transfer roller 62 or to apply the transfer roller 62 the second voltage having the first polarity opposite the second polarity of the third voltage applied to the transfer roller 62 during the image printing period. After the controller 25 completes the transfer process to transfer the image to the transfer medium, the controller 25 controls the transfer power source 24 to stop applying the voltage to the transfer roller 62 (OFF) or apply the voltage having the polarity opposite to that of the voltage applied to the transfer roller 62 during the image printing period to the transfer roller 62. Completing the transfer process to transfer the image to the transfer medium means the end of the image printing period. As illustrated in FIG. 6, since the positive voltage (for example, +1000 V) is applied to the transfer roller 62 during the image printing period as an example of the third voltage, the voltage having the polarity opposite to that of the voltage applied to the transfer roller 62 during the image printing period is the negative voltage.

In the example illustrated in FIG. 7A, applying −350 V to the charging brush roller 162 represents the latter part of the first process (a). In the latter part of the first process (a), the controller 25 controls the charging power source 21 so that the absolute value of the voltage applied to the charging brush roller 162 after the image printing period is smaller than the absolute value of the voltage applied to the charging brush roller 162 during the image printing period.

For example, the charging power source 21 applies −1100 V to the charging brush roller 162 during the image printing period as illustrated in FIG. 6 and applies-350 V to the charging brush roller 162 after the image printing period as the voltage having the smaller absolute value than the absolute value of −1100 V as illustrated in FIG. 7A. In other words, the controller 25 performs the latter process of the first process (a) to control the charging power source 21 to apply the charging brush roller 162 −350 V as an example of the fourth voltage having 350 as an example of the second absolute value smaller than 1100 as an example of the first absolute value of the first voltage. The above-described control moves the reversely charged toner (the positive toner in this example) charged to the polarity opposite the typical charging polarity of the toner from the charging brush roller 162 to the photoconductor drum 10.

In the example illustrated in FIG. 7B, applying +550 V to the transfer roller 62 represents the initial part of the second process (b). In the initial part of the second process (b), the controller 25 controls the transfer power source 24 to apply a voltage having the same polarity as the voltage applied to the transfer roller 62 during the image printing period to the transfer roller 62. In addition, the controller 25 controls the transfer power source 24 to apply the voltage so that the absolute value of the surface potential of the photoconductor drum 10 after passing through the position facing the transfer roller 62 is smaller than the absolute value of the surface potential of the photoconductor drum 10 before passing through the position facing the transfer roller 62. Since the voltage applied to the transfer roller 62 during the image printing period is +1000 V in FIG. 6, the positive voltage having the same polarity as the voltage applied to the transfer roller 62 during the image printing period is applied to the transfer roller 62 in FIG. 7B. In addition, the transfer power source 24 applies, for example, +550 V to the transfer roller 62 as a voltage having a smaller absolute value than the absolute value of +1000 V. As a result, the charge on the photoconductor drum 10 can be eliminated. As illustrated in FIG. 7B, the surface potential of the photoconductor drum 10 before passing through the position facing the transfer roller 62 (which may be referred to as the transfer position) is, for example, −500 V, and the surface potential of the photoconductor drum 10 after passing through the transfer position is, for example, −50 V. The charge on the photoconductor drum 10 is eliminated. In other words, the controller 25 performs the initial part of the second process (b) to control the transfer power source 24 to apply the transfer roller 62 the fifth voltage (for example +550 V) having the second polarity of the third voltage (for example, +1000 V) that causes the third absolute value of the first potential (for example, −50 V) on the surface of the photoconductor drum 10 downstream of the transfer position to be smaller than the fourth absolute value of the second potential (for example, −500 V) on the surface of the photoconductor drum 10 upstream of the transfer position in the rotation direction of the photoconductor drum 10.

In the example illustrated in FIG. 7B, applying a voltage of −1100 V to the charging brush roller 162 represents the latter part of the second process (b). In the latter part of the second process (b), the controller 25 controls the charging power source 21 so that the absolute value of the voltage applied to the charging brush roller 162 is larger than the absolute value of the voltage applied to the charging brush roller 162 in the above-described first process (a). In other words, the controller 25 performs the latter part of the second process (b) to control the charging power source 21 to apply the charging brush roller −1100 V as an example of the sixth voltage having an absolute value larger than 1100 as an example of the second absolute value of the fourth voltage. As a result, the discharge occurs between the charging brush roller 162 and the photoconductor drum 10. For example, the charging power source 21 applies −350 V to the charging brush roller 162 in the first process (a) as illustrated in FIG. 7A and applies −1100 V to the charging brush roller 162 as the voltage having the larger absolute value than the absolute value of −350 V as illustrated in FIG. 7B. The above-described control causes the pre-charging discharge between the charging brush roller 162 and the photoconductor drum 10. The above-described pre-charging discharge charges the reversely charged toner (the positive toner 209 in this example) that is moved onto the photoconductor drum 10 in the above-described first process (a) to the typical charging polarity of the toner (negative in this example).

As indicated by a white arrow i in FIG. 7B, the developing roller 72 collects the negatively charged toner 209, which represents the above-described third process (c). The above-described third process (c) moves the typically charged toner (the negative toner in this example) charged to the typical charging polarity of the toner in the second process (b) to the developing roller 72. In other words, the controller 25 performs the third process (c) to control the developing device to move toner having the first polarity from the photoconductor drum as the image bearer to the developing device.

As described above, the controller 25 performs the first process (a) to the third process (c) to move the transfer residual toner from the charging brush roller 162 to the developing roller 72 via the photoconductor drum 10 during the non-image printing period after the image printing period. The above-described configuration can also eliminate the charge on the surface of the photoconductor drum 10 without using the discharging device that eliminates the charge on the surface of the photoconductor drum 10.

With reference to a timing chart in FIG. 8, the following describes a timing control applicable to the above-described configurations. The controller 25 may control the voltage applied to the charging roller and the voltage applied to the charging brush roller in the same manner. The following describes the timing chart in the image forming apparatus including the charging roller 160 as an example.

In the timing chart of FIG. 8, the horizontal axis represents time, and the timing charts of members are vertically arranged. The timing chart of the exposure device is expressed by ON and OFF, and the timing charts of power sources are expressed by output voltages. The controller 25 performs these timing controls.

In FIG. 8, the timing chart of “(B) CHARGING POWER SOURCE” represents the timing control of the voltage applied to the charging roller 160. The timing chart of “(C) DEVELOPING POWER SOURCE” represents the timing control of the voltage applied to the developing roller 72. The timing chart of “(D) TRANSFER POWER SOURCE” represents the timing control of the voltage applied to the transfer roller 62.

In FIG. 8, the exposure device 5 is turned on from t1 to t2. From t1 to t2, the exposure device 5 exposes the photoconductor drum 10 as described with reference to FIG. 1.

In the present embodiment, the image printing period is defined as the period during which the transfer process is performed but may include the period during which the exposure process and the developing process are performed in addition to the period during which the transfer process is performed. In addition, the non-image printing period is defined as the period during which an image is not printed. In FIG. 8, the image printing period is from t1 to t3. The image printing period may be referred to as a printing period or the image formation period. In FIG. 8, the non-image printing period is after t3.

In the image printing period from t1 to t3, the controller 25 controls the charging power source 21 to apply the DC bias of −1100 V to the charging roller 160 and controls the developing power source 22 to apply the DC bias of −300 V to the developing roller 72 and set the potential of the developing roller 72 to −300 V. The developing roller 72 collects the typically charged toner having the first polarity (the negative toner in this example) in the transfer residual toner. The reversely charged toner having the second polarity (the positive toner in this example) moves to the charging roller 160. The movement of the reversely charged toner to the charging roller 160 is indicated by the arrow a in FIG. 4, and the reversely charged toner is illustrated as the toner 204 in FIG. 4. The collection of the typically charged toner to the developing roller 72 is indicated by the arrow c in FIG. 4. Collecting the typically charged toner on the photoconductor drum 10 into the developing roller 72 during the image printing period enables the transfer residual toner on the photoconductor drum 10 to be collected and cleans the photoconductor drum 10.

At t2, the controller 25 turns off the exposure device to complete the exposure process for printing. From t1 to t3, the transfer roller 62 transfers the typically charged toner on the photoconductor drum 10, which may be referred to as printing toner, onto the sheet 105. During a time from t2 to t3, a portion exposed by the exposure device on the photoconductor drum 10 reaches the transfer position.

At t3, the controller 25 turns off the transfer power source to stop applying the voltage to the transfer roller 62. The time t3 at which the transfer power source stops applying the voltage to the transfer roller 62 is the end time of the image printing period. At the time t3, the controller 25 performs the initial part of the first process (a). This corresponds to the transfer roller 62 being OFF in FIG. 5A.

In the initial part of the first process (a), the voltage having the polarity opposite that of the voltage applied to the transfer roller 62 during the image printing period may be applied to the transfer roller 62. The value of the voltage applied to the transfer roller 62 at this time may be selected as appropriate. The end time of the image printing period is also the time at which the transfer power source applies the transfer roller 62 the voltage having the polarity opposite that of the voltage applied to the transfer roller 62 during the image printing period.

After the transfer process is completed at the time t3, the developing roller 72 can also collect the toner from t3 to t4. The charging roller 160 negatively charges the transfer residual toner on the photoconductor drum 10 downstream of the transfer position and upstream of the charging position in the rotation direction of the photoconductor drum 10, and the developing roller 72 can collect the negatively charged toner. Turning off the transfer power source to stop applying the voltage to the transfer roller 62 at the time t3 causes the transfer roller 62 not to affect the surface potential of the photoconductor drum 10. As a result, the surface potential of the entire circumference of the photoconductor drum 10 is maintained to be −500 V at t4. As illustrated in FIG. 5A, the surface potential of the photoconductor drum 10 is −500 V at t4.

From t4 to t7, the controller 25 controls the charging power source to apply a voltage of −350 V to the charging roller 160 to set the potential of the charging roller 160 to −350 V and perform the latter part of the first process (a). In the latter part of the first process (a), the absolute value of the voltage applied to the charging roller 160 after the end of the image printing period is set to be smaller than the absolute value of the voltage applied to the charging roller 160 during the image printing period. As illustrated in FIG. 8, the voltage applied to the charging roller 160 from t4 to t7 is −350 V, and the voltage applied to the charging roller 160 from t1 to t3 is −1100 V. The absolute value of the voltage applied to the charging roller 160 from t4 to t7 is smaller than the absolute value of the voltage applied to the charging roller 160 from t1 to t3.

As described above, the potential of the photoconductor drum 10 is maintained at −500V. As a result, the relationship of the potentials is the same as that in the example illustrated in FIG. 5A. As indicated by the white arrow e in FIG. 5A, the toner held on the charging roller 160 can be moved to the photoconductor drum 10.

The period from t4 to t7 can be selected as appropriate. In this example, the charging roller 160 is rotated three times. In other words, the period from t4 to t7 is set to the time required for rotating the charging roller three times. This setting can increase the amount of toner 204 moving from the charging roller to the photoconductor drum to be the charging roller clean. For example, the period from t4 to t7 may be set to the time for rotating the charging roller 160 one time but may cause the toner to remain on the charging roller 160. In FIG. 8, D2 represents the time for rotating the charging roller 160 three times.

The period from t3 to t6 can be selected as appropriate, and in the present example, is set to the time for rotating the charging roller 160 three times. In other words, the period to perform the initial part of the first process (a) is set to the time for rotating the charging roller 160 three times. In this example, the length of three rotations of the charging roller 160 is set to be the same or substantially the same as the length of one rotation of the photoconductor drum 10, but the present disclosure is not limited to this.

In the initial part of the first process (a), the period to stop applying the voltage to the transfer roller 62 (or the period applying the transfer roller 62 the voltage having the polarity opposite to the voltage applied to the transfer roller 62 during the image printing period) is preferably set to the time for rotating the photoconductor drum 10 one time (or substantially one time). In other words, the period from t3 to t6 is preferably the time for rotating the photoconductor drum 10 one time (or substantially one time). Moving the toner from the charging roller 160 to the photoconductor drum 10 is difficult if the toner already exists on the photoconductor drum 10. Even if the time for the process to move the toner from the charging roller 160 to the photoconductor drum 10 is increased to the time for rotating the photoconductor drum 10 two times or more, the amount of toner moving from the charging roller 160 to the photoconductor drum 10 is not easily increased. For this reason, the period to move the toner from the charging roller 160 to the photoconductor drum 10 is set to the time for rotating the photoconductor drum 10 one time, which can prevent the photoconductor drum 10 from being excessively moved.

Considering the above, the time for rotating the charging roller 160 three times is preferably set to the time for rotating the photoconductor drum 10 one time. For example, the diameter of the photoconductor drum 10 in this example is set to 24 mm, and the diameter of the charging roller 160 in this example is set to 9.5 mm. Setting the time for rotating the charging roller 160 three times to be substantially equal to the time for rotating the photoconductor drum 10 one time enables the above-described control to be easily performed. The peripheral speed of the photoconductor drum 10 is not necessarily the same as the peripheral speed of the charging roller 160. In this example, the peripheral speed of the charging roller 160 is set to be 1.25 times the peripheral speed of the photoconductor drum 10. As a result, the time for rotating the charging roller 160 three times is substantially equal to the time for rotating the photoconductor drum 10 one time.

However, the period from t3 to t6 and the period from t4 to t7 may be shorter or longer than the time for rotating the photoconductor drum 10. Considering the balance between the life of the photoconductor that is shortened by wear due to a travel distance and the cleaning performance determines the period from t3 to t6 and the period from t4 to t7. Preferably, the period from t3 to t6 is set to be the same as the period from t4 to t7.

In this example, the controller 25 controls the developing power source 22 to apply +250 V to the developing roller 72 at t5 and set the potential of the developing roller 72 to +250 V. As a result, the positively charged toner 209 on the photoconductor drum 10 is not collected by the developing roller 72 and passes through the position of the developing roller 72. During the period from t4 to t5, the photoconductor drum 10 rotates from the charging position to the developing position.

At t6, the controller 25 controls the transfer power source to apply +550 V to the transfer roller 62. This corresponds to the initial part of the second process (b). Specifically, the controller 25 performs the control to apply the voltage to the transfer roller 62 in the first process (a) (in this example, the controller 25 controls the transfer power source to stop applying the voltage to the transfer roller 62 from t3 to t6). Subsequently, the controller 25 controls the transfer power source 24 to apply the transfer roller 62 the voltage having the polarity of the voltage (+1000 V) applied to the transfer roller 62 during the image printing period (the positive voltage in this example). In this example, the transfer power source 24 applies +550 V to the transfer roller 62. As a result, the absolute value of the surface potential of the photoconductor drum 10 after passing through the position facing the transfer roller 62 is smaller than the absolute value of the surface potential of the photoconductor drum 10 before passing through the position facing the transfer roller 62. In the example illustrated in FIG. 5B, the potential of the photoconductor drum 10 before passing through the transfer position is −500 V, and the potential of the photoconductor drum 10 after passing through the transfer position is −50 V. As described above, applying, for example, +550 V to the transfer roller 62 reduces charges on the photoconductor drum 10.

The value of the voltage applied to the transfer roller 62 at t6 may be selected as appropriate. As described in this example, the voltage applied to the transfer roller 62 at t6 (for example, +500V) is preferably lower than the voltage applied to the transfer roller 62 during the image printing period (for example, +1000 V). Applying such a voltage to the transfer roller 62 can prevent the photoconductor drum 10 from being excessively discharged and satisfactorily discharge the photoconductor drum 10.

This definition is described again.

In the second process (b), the controller as the circuitry controls the transfer power source to apply the transferor the voltage having the same polarity as the voltage applied to the transferor during the image printing period and preferably controls the transfer power source to set the voltage to be lower than the voltage applied to the transferor during the image printing period. In other words, the controller as the circuitry controls the transfer power source to apply the transferor the fifth voltage having the second polarity and preferably controls the transfer power source to set the fifth voltage to be lower than the third voltage applied to the transferor during the image printing period in the second process (b).

The voltage applied to the transfer roller 62 at t6 is preferably equal to or lower than 750 V as in this example. Applying such a voltage to the transfer roller 62 can prevent the photoconductor drum 10 from being excessively discharged and satisfactorily discharge the photoconductor drum 10.

This definition is described again.

In the second process (b), the controller as the circuitry controls the transfer power source to apply the transferor the voltage having the same polarity as the voltage applied to the transferor during the image printing period and preferably controls the transfer power source to set the absolute value of the voltage applied to the transferor to be equal to or lower than 750 V. In other words, the controller as the circuitry controls the transfer power source to apply the transferor the fifth voltage having the second polarity and preferably controls the transfer power source to set the fifth voltage to be equal to or lower than 750 V in the second process (b).

The voltage applied to the transfer roller 62 at t6 is supplementarily described.

During the image printing period, the transfer roller 62 applies the transfer bias voltage to the photoconductor drum 10 via the transfer medium such as the recording medium or the intermediate transferor. In contrast, during the non-image printing period, the transfer roller 62 directly contacts the photoconductor drum 10 in addition to the toner without contacting the transfer medium and reduces the charges on the photoconductor drum 10. For this reason, the transfer bias voltage smaller than the transfer bias voltage applied during the image printing period sufficiently reduces the charges on the photoconductor drum 10. The transfer bias voltage applied during the image printing period is not necessary. In order to reduce the charges on the photoconductor drum 10 during the non-image printing period, applying the transfer bias voltage during the image printing period to the photoconductor drum 10 excessively discharges the photoconductor drum 10 and changes the surface potential of the photoconductor drum 10 after passing the transfer position to be a positive potential. The positive potential of the photoconductor drum 10 reduces the absolute value of the surface potential of the photoconductor drum 10 for the next image printing and may increase the image density in the next image. Therefore, setting the voltage applied to the transfer roller 62 to reduce the charges on the photoconductor drum 10 to be lower than the voltage applied during the image printing period or to be equal to or lower than 750 V prevents the photoconductor drum 10 from being excessively discharged and prevents the image density in the next image printing from increasing.

At t7, the controller 25 controls the charging power source 21 to apply −1100 V to the charging roller 160 (in other words, switch the charging bias voltage from −350 V to −1100 V).

This corresponds to the latter part of the second process (b). After the controller 25 performs the control of applying the voltage to the charging roller 160 in the first process (a), the controller 25 controls the charging power source 21 so that the absolute value of the voltage applied to the charging roller 160 is larger than the absolute value of the voltage applied to the charging roller 160 in the above-described first process (a). In the above-described first process (a), the charging power source applies −350 V to the charging roller 160 from t4 to t7. At t7 in the second process (b), the controller 25 controls the charging power source 21 to apply −1100 V having an absolute value larger than the absolute value of 350 V. Applying the charging bias voltage as described above causes the pre-charging discharge between the charging roller 160 and the photoconductor drum 10, which charges the reversely charged toner on the photoconductor drum 10 to the typical charging polarity of the toner. In this example, the toner 209 charged to positive on the photoconductor drum 10 is reversed to negative. This may be referred to as “minus toner formation”.

Preferably, the controller 25 starts the latter part of the second process (b) after starting the initial part of the second process (b). In the example of the timing chart illustrated in FIG. 8, considering the positional relationship between the transfer position and the charging position, the controller 25 starts the initial part of the second process (b) at t6 and starts the latter part of the second process (b) at t7 after the t6.

Subsequently, the controller 25 controls the developing power source 22 to apply −300 V to the developing roller 72. As a result, the potential difference between the surface potential of the discharged and charged photoconductor drum 10 and the potential of the developing roller 72 causes the developing roller 72 to collect the negatively charged toner 209 on the photoconductor drum 10. In FIG. 5B, the positively charged toner 209 is reversed to the negative polarity, and the toner 209 reversed to the negative polarity is collected by the developing roller 72 as indicated by the white arrow i.

This corresponds to the third process (c). In the third process (c), the developing roller 72 collects the typically charged toner charged to the typical charging polarity of the toner by the above second process (b). The period for performing the third process (c) is, for example, the time for rotating the photoconductor drum 10 one time but is not limited to this. Rotating the photoconductor drum 10 one time enables the developing roller 72 to collect the toner and can prevent the photoconductor drum 10 from excessively traveling. In this example, the period to perform the third process (c) is set to t8 to t10.

For example, when all the positively charged toner on the photoconductor drum 10 is reversed to the negative polarity and collected to the developing roller 72, the controller ends the collection of the toner to the developing roller 72.

The period from t7 to t9 is set to, for example, the time for rotating the photoconductor drum 10 one time. The time for rotating the photoconductor drum 10 one time is indicated by D1 in FIG. 8. At t10, the controller 25 starts preparing the charging and developing for the next image printing. During the period from t9 to t10, the photoconductor drum 10 rotates from the charging position to the developing position.

The timing of performing the first process (a) to the third process (c) can be appropriately selected. For example, the timing of performing the first process (a) to the third process (c) may be a time between image printing and the next image printing. The controller 25 may always perform the first process (a) to the third process (c) for the time between image printing and the next image printing. Alternatively, the controller 25 may perform the first process (a) to the third process (c) for the time between image printing and the next image printing at predetermined intervals. Always performing the first process (a) to the third process (c) for the time between image printing and the next image printing can keep the charger clean and further reduce contamination of the charger. Performing the first process (a) to the third process (c) for the time between image printing and the next image printing at predetermined intervals can keep the charge clean and shorten the time required for the entire control. In addition, the controller 25 may perform the first process (a) to the third process (c) multiple times for the time between image printing and the next image printing.

Based on the above, the following describes an example of the timing of performing the first process (a) to the third process (c).

The controller performs the first process (a) to the third process (c) for the time between image printing and the next image printing. After the controller completes the first process (a) to the third process (c), the controller performs the next image printing. After the predetermined interval passes, the controller performs the first process (a) to the third process (c) for the time between image printing and the next image printing. Performing the first process (a) to the third process (c) as described above can keep the charger cleaner and further reduce the contamination of the charger.

The following describes another timing control applicable to the above-described configurations. Descriptions of matters similar to the above are omitted.

The image forming apparatus in this example performs a transfer cleaning operation. In the example illustrated in FIG. 8, the controller 25 may perform the transfer cleaning operation after performing the control of applying the voltage to the transfer roller 62 in the above second process (b). For example, the negatively charged toner adhered to the transfer roller 62 may cause the contamination of the back of the sheet in the next image printing or a transfer failure due to the contamination of the transfer roller 62 in the next image printing. In such a case, the controller 25 may perform the transfer cleaning operation. Performing the transfer cleaning operation can move the toner adhering to the transfer roller 62 to the image bearer and enables the developing roller to collect the toner, which prevents the contamination of the back of the sheet in the next image printing and the transfer failure due to the contamination of the transfer roller 62 in the next image printing.

The controller 25 in this example performs a fourth process (d) and a fifth process (e) as follows to perform the transfer cleaning operation.

(d) The controller controls the transfer power source to apply the transferor a seventh voltage having the first polarity opposite to the second polarity of the third voltage applied to the transferor during the image printing period to move the typically charged toner that is charged to the typical charging polarity (the first polarity) of the toner and adhered to the transferor to the image bearer.

(e) The typically charged toner moved to the image bearer in the control process (d) is moved to the developing roller. In other words, the controller controls the developing device to move the toner having the first polarity from the image bearer to the developing device.

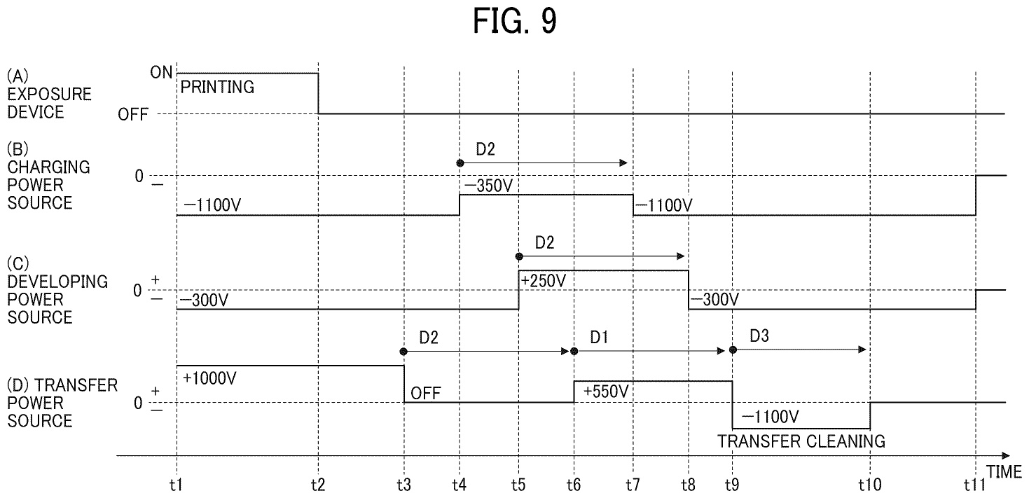

FIG. 9 is a timing chart of this control. With reference to FIG. 9, this control is described. Descriptions of matters similar to the timing chart of FIG. 8 are omitted.

The transfer cleaning operation in this example is performed from t9 to t10 in FIG. 9. At t9, the controller 25 controls the transfer power source to apply −1100 V as an example of the seventh voltage to the transfer roller 62. Since the voltage applied to the transfer roller 62 during the image printing period is positive, a negative voltage having a polarity opposite to the positive voltage is applied. The absolute value of the voltage may be appropriately determined depending on the level of contamination.

From t9 to t10, the negatively charged toner moves from the transfer roller 62 to the photoconductor drum 10, the rotation of the photoconductor drum 10 moves the negatively charged toner to the developing roller 72, and the developing roller 72 collects the negatively charged toner. As a result, the control processes (d) and (e) are performed from 19 to t10.

At t9, the photoconductor drum 10 completes rotating one time, and the transfer roller 62 finishes eliminating the charge on the photoconductor drum 10. In other words, the photoconductor drum 10 rotates one time from t6 to t9 as indicated by D1 in FIG. 9. At t9, the controller 25 completes the control to apply the voltage (+550 V in this example) to the transfer roller 62 in the second process (b).

The period to perform the transfer cleaning operation, that is, the period from t9 to t10 can be selected as appropriate. For example, the transfer cleaning operation in this example is performed while the transfer roller 62 rotates two times, and the period to perform the transfer cleaning operation is indicated as D3 in FIG. 9. The period to perform the transfer cleaning operation may be appropriately determined depending on the level of contamination.

The timing of performing the above control processes (d) and (e) can be appropriately selected. For example, the timing of performing the control processes (d) and (e) may be a time between image printing and the next image printing. The controller 25 may always perform the control processes (d) and (e) for the time between image printing and the next image printing. Alternatively, the controller 25 may perform the control processes (d) and (e) for the time between image printing and the next image printing at predetermined intervals. Always performing the control processes (d) and (e) for the time between image printing and the next image printing can keep the transferor clean and further reduce contamination of the transferor. Performing the control processes (d) and (e) for the time between image printing and the next image printing at predetermined intervals can keep the transferor clean and shorten the time required for the entire control. In addition, the controller 25 may perform the control processes (d) and (e) multiple times for the time between image printing and the next image printing.

Based on the above, the following describes an example of the timing of performing the control processes (d) and (e).

The controller performs the control processes (d) and (e) for the time between image printing and the next image printing. After the controller completes the control processes (d) and (e), the controller performs the next image printing. After the predetermined interval passes, the controller performs the control processes (d) and (e) for the time between image printing and the next image printing. Performing the control processes (d) and (e) as described above can keep the transferor clean and further reduce the contamination of the transferor.

The following describes another timing control applicable to the above-described configurations. Descriptions of matters similar to the above are omitted.

The image forming apparatus in this example performs a charger cleaning operation, which may be referred to as a cleaning mode. For example, the controller 25 may perform the charger cleaning operation to clean the toner remaining on the charging roller 160 after the first process (a) to the third process (c). The controller 25 may perform the charger cleaning operation, for example, during a shutdown process of the image printing operation or before the preparation for the next image printing.

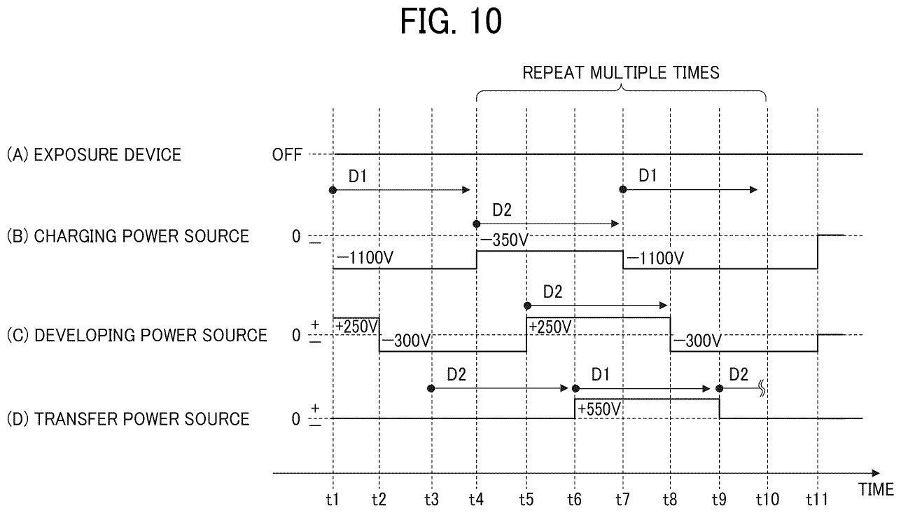

FIG. 10 is a timing chart of this control. With reference to FIG. 10, this control is described. Descriptions of matters similar to the above are omitted.

The controller 25 starts the charger cleaning operation from t1 in FIG. 10. The time t1 in FIG. 10 may be t10 in FIG. 8. The controller performs the charger cleaning operation during the non-image printing period.

At t1, the charging roller 160 starts to charge the surface of the photoconductor drum 10 at the charging position, and a portion charged by the charging roller 160 on the photoconductor drum 10 reaches the developing position at t2. Therefore, from t1 to t2, the surface of the photoconductor drum 10 at the developing position is not charged by the charging roller 160. Not to move the negatively charged toner from the developing roller 72 to the photoconductor drum 10, the controller 25 controls the developing power source to apply +250 V to the developing roller 72.

During a period from t1 to t4, the controller 25 controls the charging power source 21 to apply −1100 V to the charging roller 160. In addition, the photoconductor drum 10 rotates one time during the period from t1 to t4 as indicated by D1 in FIG. 10. Applying −1100 V to the charging roller 160 during the period from t1 to t4 while the photoconductor drum 10 rotates one time charges the surface of the photoconductor drum 10 to, for example, −500 V. From t4 to t10 in FIG. 10, the charging roller 160 and the photoconductor drum 10 have the same potential relationship as that from t3 to t9 in FIG. 8, and the toner moves from the charging roller 160 to the photoconductor drum 10 and is further collected by the developing roller 72.

As illustrated in FIG. 10, the controller 25 in this example repeats the control processes (in other words, operations) performed from t4 to t10. Repeating the control processes performed from t4 to t10 in FIG. 10 discharges toner from the charging roller 160 multiple times, which further cleans the charging roller 160. After repeating the control processes, at t11, the controller 25 performs the same operations as those after t8 in FIG. 8. Performing the control processes as described above can keep the charging roller 160 clean and prevent the occurrence of a charging failure and an abnormal image that are caused by the contamination of the charging roller 160.

The period from t4 to t7 in this example is set to a time for which the charging roller 160 rotates three times, which is indicated by D2 in FIG. 10. The above-described period enables the charging roller 160 to be cleaned and can prevent the operation time from becoming too long. However, in order to increase the cleaning performance by increasing the amount of toner discharged from the charger, the period from t4 to t7 may be set to be longer than the time for which the charging roller 160 rotates three times. The number of times of repeating the control processes from t4 to t10 can be appropriately selected and may be increased in order to increase the cleaning performance.

Preferably, the controller performs the charger cleaning operation (the cleaning mode) at predetermined intervals so that the contamination of the transfer residual toner does not accumulate on the charger. The predetermined interval is preferably determined using a parameter correlated with an increase in contamination, such as an integrated number of print dot counts or an integrated value of the travel distance. The image forming apparatus may be designed so that the user can instruct the execution of the cleaning mode.

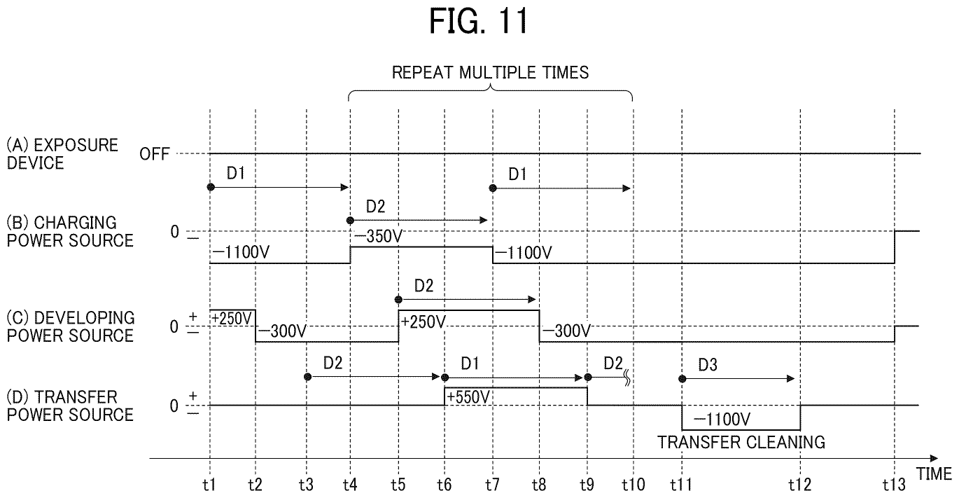

FIG. 11 is another example of a timing chart. Descriptions of matters similar to the above are omitted.

In the example illustrated in FIG. 11, the controller 25 performs the transfer cleaning operation in addition to the example illustrated in FIG. 10. In FIG. 11, the controller 25 performs the transfer cleaning operation described with reference to FIG. 10 in a period from t11 to t12. The image forming apparatus in this example performs the transfer cleaning operation in addition to the charger cleaning operation of the charging member, which can keep the image forming apparatus cleaner.

The following describes another control and configuration applicable to the above-described configurations. Descriptions of matters similar to the above are omitted.

The image forming apparatus in this example includes a contact-separation mechanism that contacts the transfer roller 62 to the photoconductor drum 10 and separates the transfer roller 62 from the photoconductor drum 10. The controller in this example controls the contact-separation mechanism to separate the transfer roller 62 from the photoconductor drum 10 while performing the first process (a). The above-described configuration and control can prevent the reversely charged toner (for example, the positively charged toner in this example) from adhering to the transfer roller 62 when the reversely charged toner passes through the transfer position. After the controller performs the first process (a), the controller 25 controls the contact-separation mechanism to contact the transfer roller 62 to the photoconductor drum 10 to perform the second process (b). The above-described configuration and control can prevent the control of separating the transfer roller 62 from affecting the charge elimination of the photoconductor drum 10.

The above example is described again.

The image forming apparatus includes the contact-separation mechanism to bring the transferor into contact with and separate the transferor from the image bearer, and the controller controls the contact-separation mechanism to separate the transferor from the image bearer from the start of the first process (a) to the end of the first process (a) and bring the transferor into contact with the image bearer to perform the second process (b).

The controller 25 controls the contact-separation mechanism to separate the transfer roller 62 from the photoconductor drum 10, for example, in a period from t3 to t6 in FIG. 8. In this case, the controller 25 controls the contact-separation mechanism to bring the transfer roller 62 into contact with the photoconductor drum 10 at t6 in FIG. 8.

As described above, the controller controls the contact-separation mechanism to bring the transfer roller 62 into contact with and separate from the photoconductor drum 10. The contact-separation mechanism can be selected as appropriate.

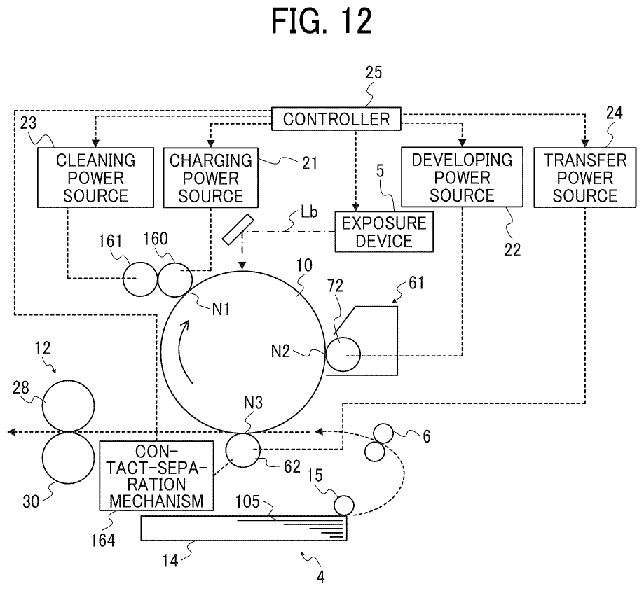

FIG. 12 is a schematic diagram illustrating the image forming apparatus including a contact-separation mechanism 164. As illustrated in FIG. 12, the image forming apparatus includes the contact-separation mechanism 164 controlled by the controller 25 to bring the transfer roller 62 into contact with or separate the transfer roller 62 from the photoconductor drum 10.

The contact-separation mechanism 164 may be configured by, for example, a cam that contacts the shaft of the transfer roller 62 and a cam drive motor that drives and rotates the cam. The controller 25 can control the cam drive motor to rotate the cam to displace the transfer roller 62 to a position at which the transfer roller 62 is in contact with the photoconductor drum 10 and a position at which the transfer roller 62 is separated from the photoconductor drum 10. The contact-separation mechanism 164 may include a solenoid to move the transfer roller 62, instead of the cam mechanism.

Another example is described below. Descriptions of matters similar to the above are omitted.

The image forming apparatus in this example includes a temperature sensor and a humidity sensor, and the controller calculates an absolute humidity based on a temperature detected by the temperature sensor and a humidity detected by the humidity sensor and controls the voltage applied to the charger such as the charging roller based on the absolute humidity.

In other words, the controller controls the voltage applied to the charger based on the absolute humidity inside or outside the image forming apparatus. The controller performs the above-described control during the image printing period and/or the non-image printing period.

Specifically, the controller performs the control as follows. The memory in the image forming apparatus stores a table including multiple absolute humidity ranges and optimum voltages applied to the charging roller corresponding to the multiple absolute humidity ranges in advance. The controller selects the optimum voltage applied to the charging roller from the table based on the absolute humidity and sets the optimum voltage.

The controller calculates the absolute humidity based on the output of the temperature sensor and the output of the humidity sensor that detect the temperature and humidity inside or outside the image forming apparatus. Based on the calculated absolute humidity, the controller selects the optimum voltage applied to the charging roller from the table stored in the memory of the image forming apparatus in advance and sets the optimum voltage as the voltage used for the next image formation.

The lower the absolute humidity, the larger the charge amount of toner is. For this reason, the controller sets a higher voltage applied to the charging roller for the image formation to maintain an image density when the absolute humidity is low. In addition, the controller sets a lower voltage applied to the charging roller to cause the pre-charging discharge to collect the transfer residual toner in the developing device when the absolute humidity is low, which prevents the transfer residual toner from being excessively charged. According to the above, the controller can control the pre-charging discharge to suitably and stably charge the transfer residual toner to an appropriate charge amount without being influenced by the change in the absolute humidity.

Aspects of the present disclosure are, for example, as follows.

### First Aspect

In a first aspect, an image forming apparatus includes an image bearer, a charger, a charging power source, a developing device, a transferor, a transfer power source, and a controller that is circuitry. The image bearer is rotatable in a rotation direction. The charger is in contact with the image bearer to charge the image bearer. The charging power source applies a voltage to the charger. The developing device charges toner to a first polarity, supplies toner to the image bearer, and forms a toner image on the image bearer. The transferor faces the image bearer to transfer the toner image onto a transfer medium at a transfer position. The transfer power source applies a voltage to the transferor. During an image printing period, the controller is configured to perform a first collection operation to collect, to the charger, a part of transfer residual toner remaining on the image bearer after the transferor transfers the toner image to the transfer medium. During a non-image printing period, the controller is configured to perform a second collection operation to move the transfer residual toner collected to the charger from the charger to the developing device via the image bearer. The controller is further configured to perform the first collection operation to move reversely charged toner that is charged to a second polarity opposite the first polarity from the image bearer to the charger applied with a direct current bias with a first voltage having a first absolute value. The controller is further configured to perform the second collection operation to perform a first process (a), a second process (b), and a third process (c). In the first process (a), the controller is configured to control the transfer power source to stop applying the voltage to the transferor or to apply the transferor a second voltage having the first polarity opposite the second polarity of a third voltage applied to the transferor during the image printing period and control the charging power source to apply the charger a fourth voltage having a second absolute value smaller than the first absolute value of the first voltage to move the reversely charged toner from the charger to the image bearer. In the second process (b), the controller is configured to control the transfer power source to apply the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. In the second process (b), the controller is configured to control the charging power source to apply the charger a sixth voltage having an absolute value larger than the second absolute value of the fourth voltage. In the third process (c), the controller is configured to control the developing device to move toner having the first polarity from the image bearer to the developing device.

### Second Aspect

In a second aspect, the controller in the image forming apparatus according to the first aspect is further configured to control the transfer power source to apply the transferor the fifth voltage lower than the third voltage.

### Third Aspect

In a third aspect, the controller in the image forming apparatus according to the first aspect or the second aspect is further configured to control the transfer power source apply the transferor the fifth voltage equal to or lower than 750 V.

### Fourth Aspect

In a fourth aspect, the image forming apparatus according to any one of the first to third aspects includes a contact-separation mechanism to bring the transferor into contact with and separate from the image bearer, and the controller is further configured to control the contact-separation mechanism to separate the transferor from the image bearer during the first process (a); and bring the transferor into contact with the image bearer during the second process (b).

### Fifth Aspect

In a fifth aspect, the controller in the image forming apparatus according to any one of the first to fourth aspects is further configured to perform the first process (a) to the third process (c) at predetermined intervals from an end of the image printing period to a time before a start of the next image printing period and start the next image printing period after an end of the first process (a) to the third process (c).

### Sixth Aspect

In a sixth aspect, the controller in the image forming apparatus according to any one of the first to fifth aspects is further configured to perform a fourth process (d) and a fifth process (e). In the fourth process (d), the controller is configured to control the transfer power source to apply the transferor a seventh voltage having the first polarity opposite the second polarity of the third voltage applied to the transferor during the image printing period. In the fifth process (e), the controller is configured to control the developing device to move the toner having the first polarity from the image bearer to the developing device.

### Seventh Aspect

In a seventh aspect, the controller in the image forming apparatus according to the sixth aspect is further configured to perform the fourth process (d) and the fifth process (e) at predetermined intervals from an end of the image printing period to a time before a start of the next image printing period and start the next image printing period after an end of the fourth process (d) and the fifth process (e).

### Eighth Aspect

In an eighth aspect, the controller in the image forming apparatus according to any one of the first to seventh aspects is further configured to control the charging power source to apply a voltage based on an absolute humidity inside or outside the image forming apparatus.

### Ninth Aspect

In a ninth aspect, the controller in the image forming apparatus according to any one of the first to eighth aspects is configured to perform the first process (a) to move the reversely charged toner from the charger to the image bearer and perform the second process (b) to cause discharge between the charger and the image bearer and charge the toner on the image bearer to the typical charging polarity.

### Tenth Aspect

In a tenth aspect, the controller in the image forming apparatus according to the sixth to ninth aspects is configured to perform the fourth process (d) to move the toner having the first polarity from the transferor to the image bearer.

### Eleventh Aspect

In an eleventh aspects, a method to collect the transfer residual toner is performed by an image forming apparatus including an image bearer rotatable in a rotation direction, a charger in contact with the image bearer to charge the image bearer, a developing device to charge toner to a first polarity, supply toner to the image bearer, and form a toner image on the image bearer, and a transferor facing the image bearer to transfer the toner image to a transfer medium at a transfer position. The method is performed to collect transfer residual toner remaining on the image bearer after the transferor transfers the toner image. The method includes performing a first collection operation during an image printing period to collect a part of the transfer residual toner to the charger and performing a second collection operation during a non-image printing period to move the transfer residual toner collected to the charger from the charger to the developing device via the image bearer. The first collection operation includes moving reversely charged toner that is charged to a second polarity opposite the first polarity from the image bearer to the charger applied with a direct current bias with a first voltage having a first absolute value. The second collection operation includes performing a first process (a), a second process (b), and a third process (c). The first process (a) includes either stopping applying a voltage to the transferor or applying the transferor a second voltage having the first polarity opposite the second polarity of a third voltage applied to the transferor during the image printing period. The first process (a) includes applying the charger a fourth voltage having a second absolute value smaller than the first absolute value of the first voltage to move the reversely charged toner from the charger to the image bearer. The second process (b) includes applying the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction. The second process (b) includes applying the charger a sixth voltage having an absolute value larger than the second absolute value of the fourth voltage. The third process (c) includes moving toner having the first polarity from the image bearer to the developing device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image bearer rotatable in a rotation direction;
a charger in contact with the image bearer to charge the image bearer;
a charging power source to apply voltage to the charger;
a developing device to charge toner to a first polarity, supply toner to the image bearer, and form a toner image on the image bearer;
a transferor facing the image bearer to transfer the toner image onto a transfer medium at a transfer position;
a transfer power source to apply voltage to the transferor; and
circuitry configured to:
perform, during an image printing period, a first collection operation to collect, to the charger, a part of transfer residual toner remaining on the image bearer after the transferor transfers the toner image to the transfer medium; and
perform, during a non-image printing period, a second collection operation to move the transfer residual toner collected to the charger from the charger to the developing device via the image bearer,
wherein the circuitry is further configured to:
perform the first collection operation to move, from the image bearer to the charger, reversely charged toner that is charged to a second polarity opposite the first polarity, the charger applied with a direct current bias with a first voltage having a first absolute value; and
perform the second collection operation to:
perform a first process (a) to control the transfer power source:
to stop applying the voltage to the transferor; or
to apply the transferor a second voltage having the first polarity opposite the second polarity of a third voltage applied to the transferor during the image printing period; and
control the charging power source to apply the charger a fourth voltage having a second absolute value smaller than the first absolute value of the first voltage to move the reversely charged toner from the charger to the image bearer;
perform a second process (b) to:
control the transfer power source to apply the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction; and
control the charging power source to apply the charger a sixth voltage having an absolute value larger than the second absolute value of the fourth voltage; and
perform a third process (c) to control the developing device to move toner having the first polarity from the image bearer to the developing device.

2. The image forming apparatus according to claim 1,
wherein the circuitry is further configured to control the transfer power source to apply the transferor the fifth voltage lower than the third voltage.

3. The image forming apparatus according to claim 1,
wherein the circuitry is further configured to control the transfer power source to apply the transferor the fifth voltage equal to or lower than 750 V.

4. The image forming apparatus according to claim 1, further comprising
a contact-separation mechanism to bring the transferor into contact with and separate from the image bearer,
wherein the circuitry is further configured to control the contact-separation mechanism to:
separate the transferor from the image bearer during the first process (a); and
bring the transferor into contact with the image bearer during the second process (b).

5. The image forming apparatus according to claim 1,
wherein the circuitry is further configured to:
perform the first process (a) to the third process (c) at predetermined intervals from an end of the image printing period to a time before a start of the next image printing period; and
start the next image printing period after an end of the first process (a) to the third process (c).

6. The image forming apparatus according to claim 1,
wherein the circuitry is further configured to:
perform a fourth process (d) to control the transfer power source to apply the transferor a seventh voltage having the first polarity opposite the second polarity of the third voltage applied to the transferor during the image printing period; and
perform a fifth process (e) to control the developing device to move the toner having the first polarity from the image bearer to the developing device.

7. The image forming apparatus according to claim 6,
wherein the circuitry is further configured to:
perform the fourth process (d) and the fifth process (e) at predetermined intervals from an end of the image printing period to a time before a start of the next image printing period; and
start the next image printing period after an end of the fourth process (d) and the fifth process (e).

8. The image forming apparatus according to claim 1,
wherein the circuitry is further configured to control the charging power source to apply a voltage based on an absolute humidity inside or outside the image forming apparatus.

9. The image forming apparatus according to claim 1,
wherein the circuitry is configured to:
perform the first process (a) to move the reversely charged toner from the charger to the image bearer; and
perform the second process (b) to cause discharge between the charger and the image bearer and charge the toner on the image bearer to the first polarity.

10. The image forming apparatus according to claim 6,
wherein the circuitry is configured to perform the fourth process (d) to move the toner having the first polarity from the transferor to the image bearer.

11. A method performed by an image forming apparatus including an image bearer rotatable in a rotation direction, a charger in contact with the image bearer to charge the image bearer, a developing device to charge toner to a first polarity, supply toner to the image bearer, and form a toner image on the image bearer, and a transferor facing the image to transfer the toner image onto a transfer medium at a transfer position, to collect transfer residual toner remaining on the image bearer after the transferor transfers the toner image, comprising:
performing, during an image printing period, a first collection operation to collect, to the charger, a part of the transfer residual toner; and
performing, during a non-image printing period, a second collection operation to move the transfer residual toner collected to the charger from the charger to the developing device via the image bearer,
wherein the first collection operation includes moving, from the image bearer to the charger, reversely charged toner that is charged to a second polarity opposite the first polarity, the charger applied with a direct current bias with a first voltage having a first absolute value; and
the second collection operation includes:
performing a first process (a) including:
either stopping applying a voltage to the transferor, or
applying the transferor a second voltage having the first polarity opposite the second polarity of a third voltage applied to the transferor during the image printing period; and
applying the charger a fourth voltage having a second absolute value smaller than the first absolute value of the first voltage to move the reversely charged toner from the charger to the image bearer;
performing a second process (b) including:
applying the transferor a fifth voltage having the second polarity of the third voltage that causes a third absolute value of a first potential on a surface of the image bearer downstream of the transfer position to be smaller than a fourth absolute value of a second potential on the surface of the image bearer upstream of the transfer position in the rotation direction; and
applying the charger a sixth voltage having an absolute value larger than the second absolute value of the fourth voltage; and
performing a third process (c) to move toner having the first polarity from the image bearer to the developing device.
